(19) United States
(12) Patent Application Publication
(10) Pub. No.: US 2019/0162929 A1
(43) Pub. Date: May 30, 2019

(54) LENS DRIVING APPARATUS, PHOTOGRAPHING MODULE AND ELECTRONIC DEVICE

(71) Applicant: LARGAN DIGITAL CO., LTD., Taichung City (TW)

(72) Inventors: Te-Sheng TSENG, Taichung City (TW); Wen-Hung HSU, Taichung City (TW); Ming-Ta CHOU, Taichung City (TW)

(21) Appl. No.: 16/104,314

(22) Filed: Aug. 17, 2018

(30) Foreign Application Priority Data
Nov. 30, 2017 (TW) 106141941

(51) Int. Cl. G02B 7/09; H02K 41/035; G03B 13/36; G02B 13/00; H02K 11/215

(52) U.S. Cl. CPC G02B 7/09; H02K 41/0356; H02K 11/215; G02B 13/001; G03B 13/36

(57) ABSTRACT

A lens driving apparatus is for driving a lens assembly and includes a holder, a metal cover, a carrier, at least one detection magnet, at least one position detection unit, a coil and at least two driving magnets. The position detection unit is disposed on the holder, wherein the position detection unit is for detecting a displacement along a direction parallel to a central axis of the detection magnet. The holder further includes a plurality of terminal portions and a plurality of conductive portions. The terminal portions are extended outward from the holder along the direction parallel to the central axis. The conductive portions are exposed on a surface of the holder, wherein four of the conductive portions are arranged as a grid array of two rows and two columns, and the four of the conductive portions are disposed correspondingly to the position detection unit.

### RELATED APPLICATIONS

This application claims priority to Taiwan Application Serial Number 106141941, filed Nov. 30, 2017, which is herein incorporated by reference.

### BACKGROUND

### Technical Field

The present disclosure relates to a lens driving apparatus and a photographing module. More particularly, the present disclosure relates to a lens driving apparatus and a photographing module which are applicable to portable electronic devices.

### Description of Related Art

In general, the voice coil motor (VCM) acting as a lens driving apparatus is applied to the lens assembly in the electronic device for providing an is auto-focusing function, and at least one leaf spring of the lens driving apparatus is assembled on the carrier. When the leaf spring is deformed by force to provide degrees of freedom and restoring force for the carrier, the lens assembly can be carried to be displaced by the carrier so as to achieve the auto-focusing function.

However, this kind of lens driving apparatus usually includes quite numerous parts. In order to meet the demands of accurate and smooth displacement of the lens assembly, it is required lots of alignment and calibration steps during the assembling procedure of the lens driving apparatus so as to finish accurately assembling the lens driving apparatus from the parts one by one. Thus, it limits the production efficiency and the manufacturing yield rate of the lens driving apparatus.

Given the above, how to improve the production efficiency while maintaining the assembling accuracy, achieve the fast focusing function of the photographing module, and thereby satisfy the requirements of the electronic devices in high-end imaging has become one of the important subjects related to a lens driving apparatus.

### SUMMARY

According to one aspect of the present disclosure, a lens driving apparatus is for driving a lens assembly and includes a holder, a metal cover, a carrier, at least one detection magnet, at least one position detection unit, a coil and at least two driving magnets. The holder includes a holder opening. The metal cover is coupled to the holder and includes a cover opening, which is disposed correspondingly to the holder opening. The carrier having a central axis is for being assembled with the lens assembly, wherein the carrier is disposed in the metal cover, and the carrier is displaceable relative to the holder along a direction parallel to the central axis. The detection magnet is coupled to an end of the carrier, wherein the end of the carrier is close to the holder. The position detection unit is disposed on the holder and correspondingly to the detection magnet, wherein the position detection unit is for detecting a displacement along the direction parallel to the central axis of the detection magnet. The coil is wound around and disposed on an outer surface of the carrier. The driving magnets are disposed in the metal cover and correspondingly to the coil. The holder further includes a plurality of terminal portions and a plurality of conductive portions. The terminal portions are extended outward from the holder along the direction parallel to the central axis. The conductive portions are exposed on a surface of the holder, wherein four of the conductive portions are arranged as a grid array of two rows and two columns, and the four of the conductive portions are disposed correspondingly to the position detection unit.

According to another aspect of the present disclosure, a photographing module includes the lens driving apparatus according to the foregoing aspect and the lens assembly. The lens assembly is assembled with the carrier of the lens driving apparatus.

According to another aspect of the present disclosure, an electronic device includes the photographing module according to the foregoing aspect and an image sensor. The image sensor is for receiving an imaging light from the lens assembly.

According to another aspect of the present disclosure, a lens driving apparatus is for driving a lens assembly and includes a holder, a metal cover, a carrier, at least one detection magnet, at least one position detection unit, a coil and at least two driving magnets. The holder includes a holder opening. The metal cover is coupled to the holder and includes a cover opening, which is disposed correspondingly to the holder opening. The carrier having a central axis is for being assembled with the lens assembly, wherein the carrier is disposed in the metal cover, and the carrier is displaceable relative to the holder along a direction parallel to the central axis. The detection magnet is coupled to an end of the carrier, wherein the end of the carrier is close to the holder. The position detection unit is disposed on the holder and correspondingly to the detection magnet, wherein the position detection unit is for detecting a displacement along the direction parallel to the central axis of the detection magnet. The coil is wound around and disposed on an outer surface of the carrier. The driving magnets are disposed in the metal cover and correspondingly to the coil. The holder further includes a plurality of terminal portions and a plurality of conductive portions. The terminal portions are extended outward from the holder along the direction parallel to the central axis. The conductive portions are exposed on a surface of the holder, wherein at least four of the conductive portions are disposed correspondingly to the position detection unit.

According to another aspect of the present disclosure, a photographing module includes the lens driving apparatus according to the foregoing aspect and the lens assembly. The lens assembly is assembled with the carrier of the lens driving apparatus.

According to another aspect of the present disclosure, an electronic device includes the photographing module according to the foregoing aspect and an image sensor. The image sensor is for receiving an imaging light from the lens assembly.

### BRIEF DESCRIPTION OF THE DRAWINGS

FIG. 1A is an exploded view of a lens driving apparatus with a lens assembly according to the 1st embodiment of the present disclosure;

FIG. 1B is another exploded view of the lens driving apparatus with the lens assembly according to the 1st embodiment;

FIG. 1C is a schematic view of the lens driving apparatus with the lens assembly and an image sensor according to the 1st embodiment;

FIG. 1D is a side view of a holder of the lens driving apparatus according to the 1st embodiment;

FIG. 1E is a schematic view of a lower leaf spring and the holder according to FIG. 1A;

FIG. 1F is a schematic view of the holder according to FIG. 1B;

FIG. 1G is a schematic view of the holder and a position detection unit according to the 1st embodiment;

FIG. 1H is a schematic view of a plastic part and a conductive part of the holder according to the 1st embodiment;

FIG. 1I is a schematic view of the conductive part of the holder according to the 1st embodiment;

FIG. 1J is a schematic view of some of conductive portions of the holder according to the 1st embodiment;

FIG. 1K is a schematic view of some of the conductive portions of the holder and the position detection unit according to the 1st embodiment;

FIG. 1L is a three-dimensional view of the position detection unit according to the 1st embodiment;

FIG. 1M is a bottom view of the position detection unit according to the 1st embodiment;

FIG. 1N is a schematic view of terminal portions of the holder according to the 1st embodiment;

FIG. 1O is a schematic view of a carrier and a detection magnet according to FIG. 1B;

FIG. 2A is a schematic view of a plastic part and a conductive part of a holder of a lens driving apparatus according to the 2nd embodiment of the present disclosure;

FIG. 2B is a schematic view of some of conductive portions of the holder and a position detection unit according to the 2nd embodiment;

FIG. 2C is a three-dimensional view of the position detection unit according to the 2nd embodiment;

FIG. 2D is a bottom view of the position detection unit according to the 2nd embodiment;

FIG. 3A is a schematic view of a plastic part and a conductive part of a holder of a lens driving apparatus according to the 3rd embodiment of the present disclosure;

FIG. 3B is a schematic view of some of conductive portions of the holder and a position detection unit according to the 3rd embodiment;

FIG. 3C is a three-dimensional view of the position detection unit according to the 3rd embodiment;

FIG. 3D is a bottom view of the position detection unit according to the 3rd embodiment;

FIG. 4A shows a schematic view of an electronic device according to the 4th embodiment of the present disclosure;

FIG. 4B shows another schematic view of the electronic device according to the 4th embodiment;

FIG. 4C shows a block diagram of the electronic device according to the 4th embodiment;

FIG. 5 shows an electronic device according to the 5th embodiment of the present disclosure;

FIG. 6 shows an electronic device according to the 6th embodiment of the present disclosure; and

FIG. 7 shows an electronic device according to the 7th embodiment of the present disclosure.

### DETAILED DESCRIPTION

### 1st Embodiment

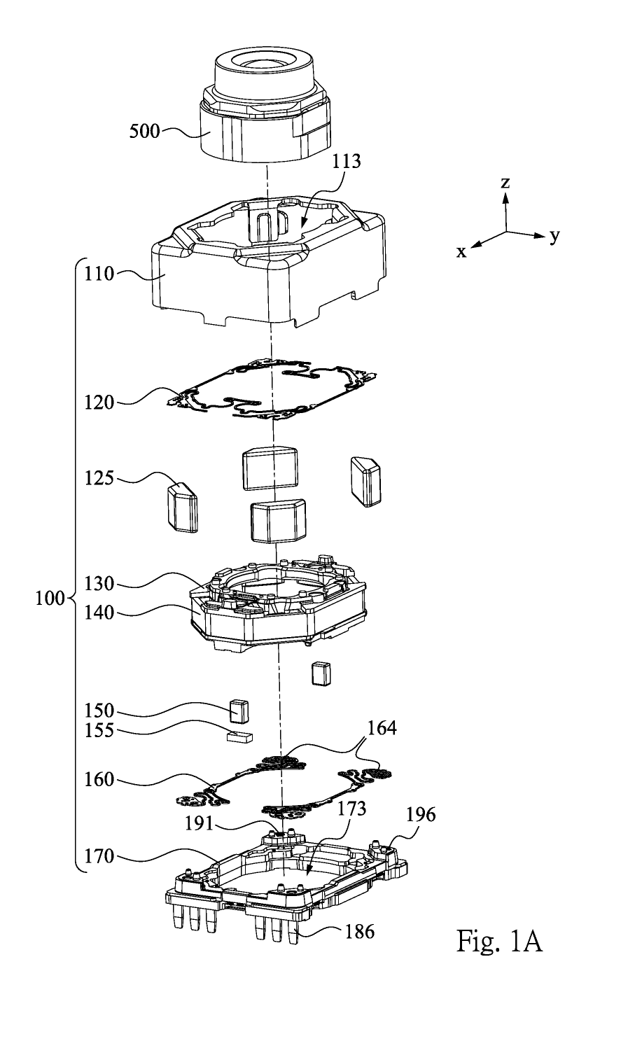

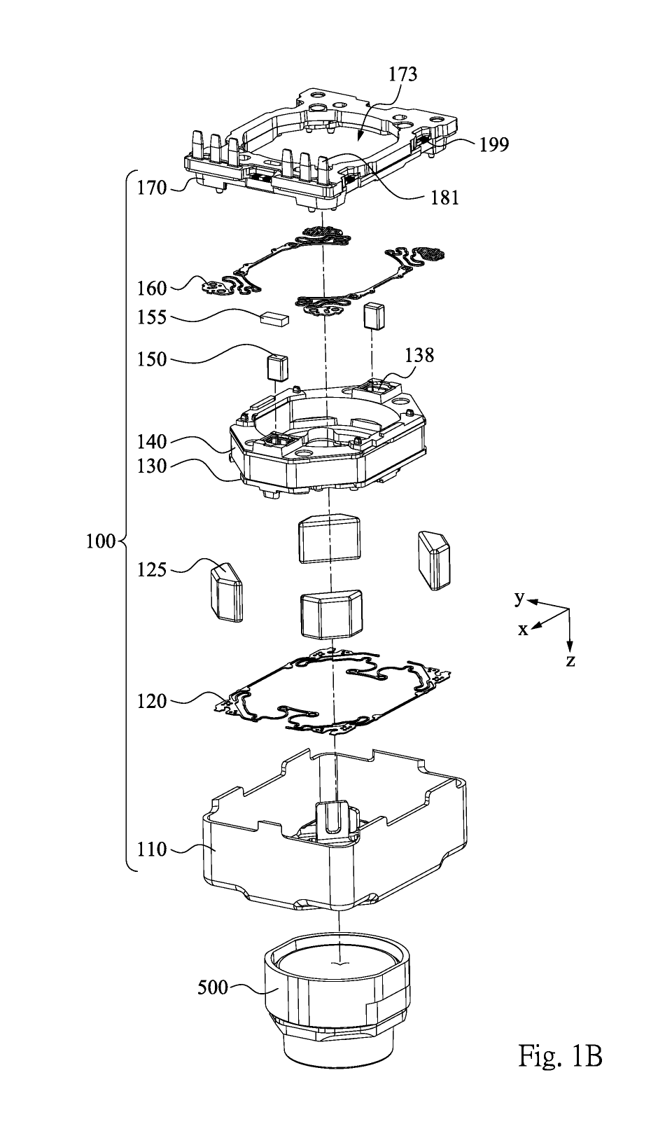

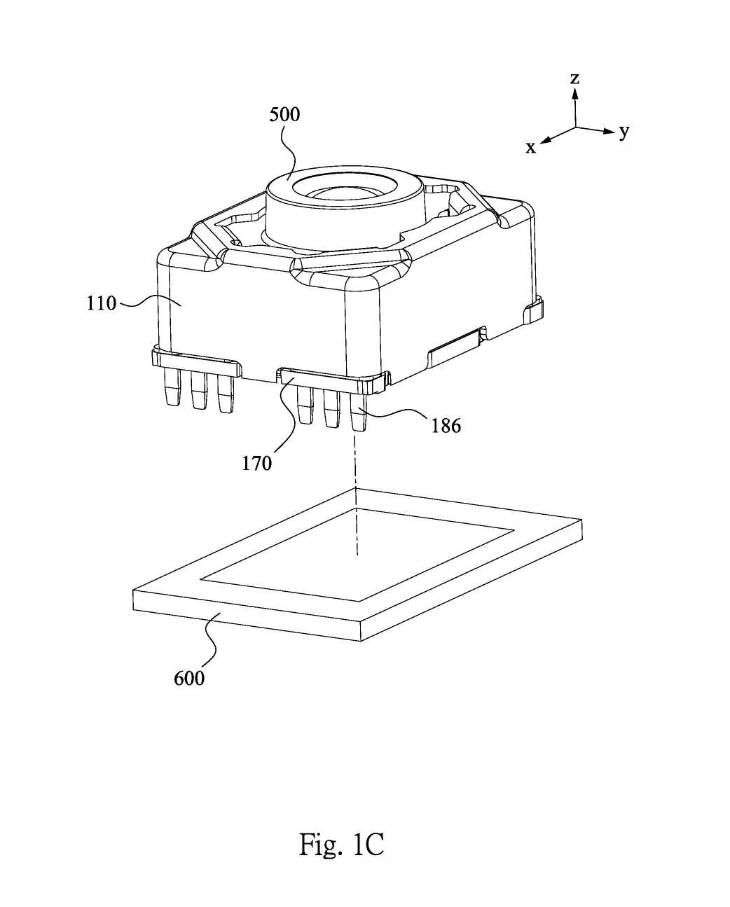

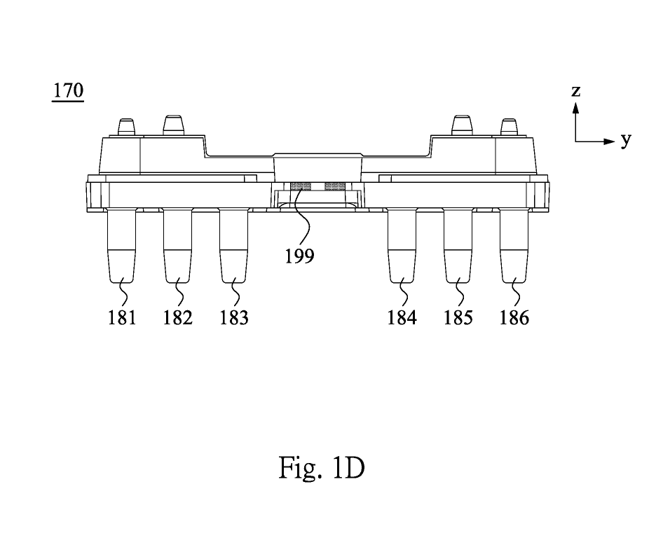

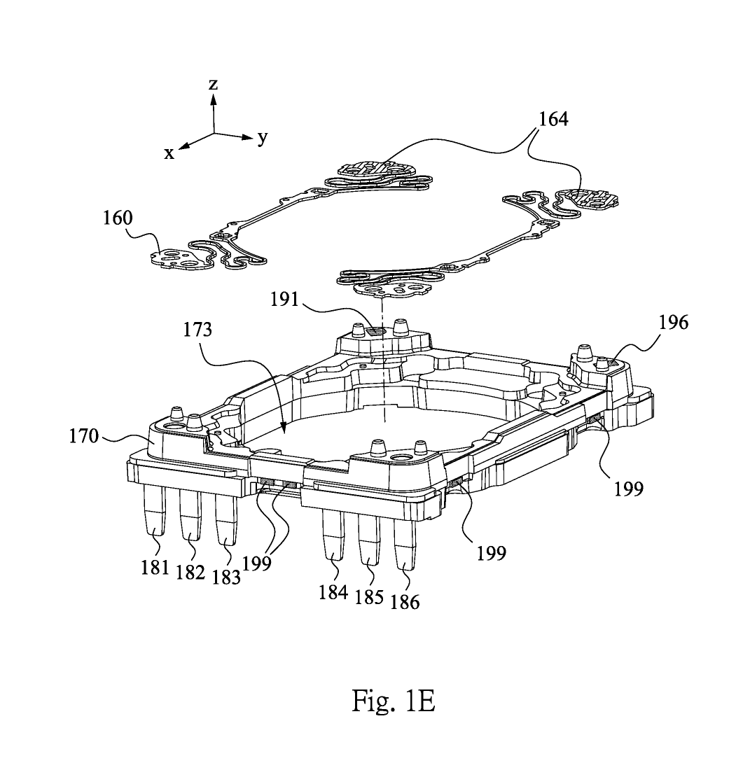

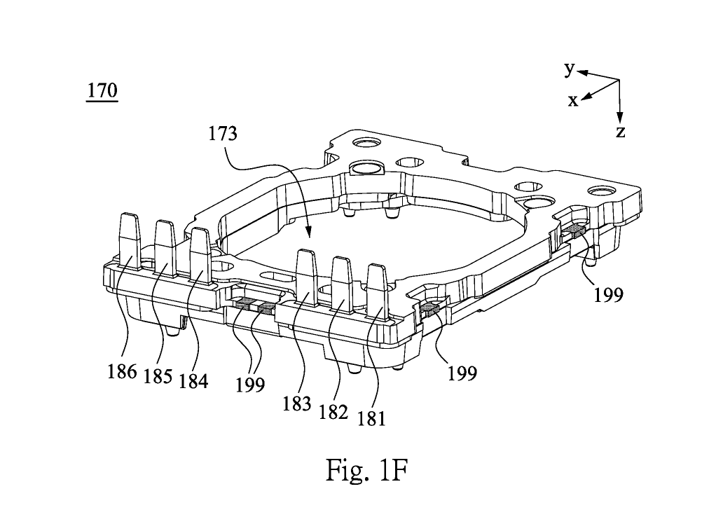

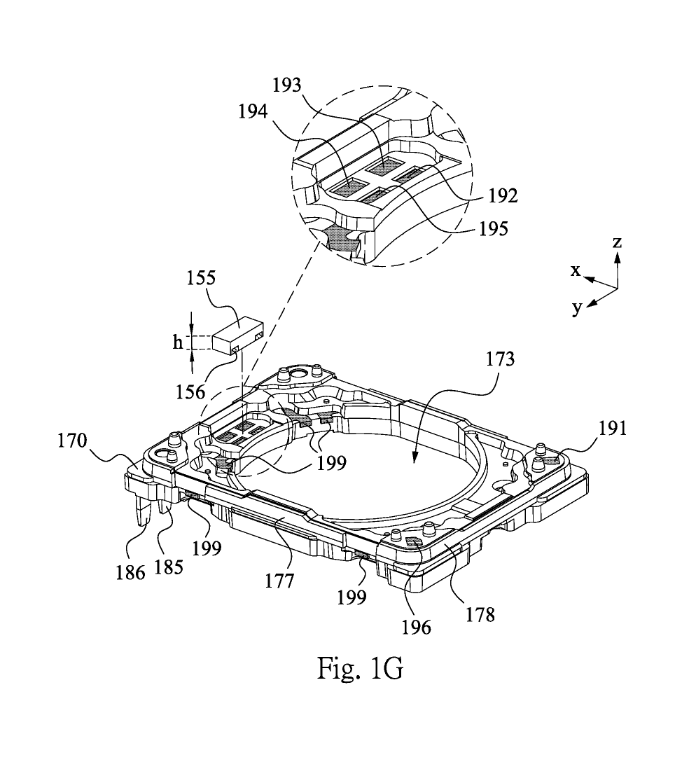

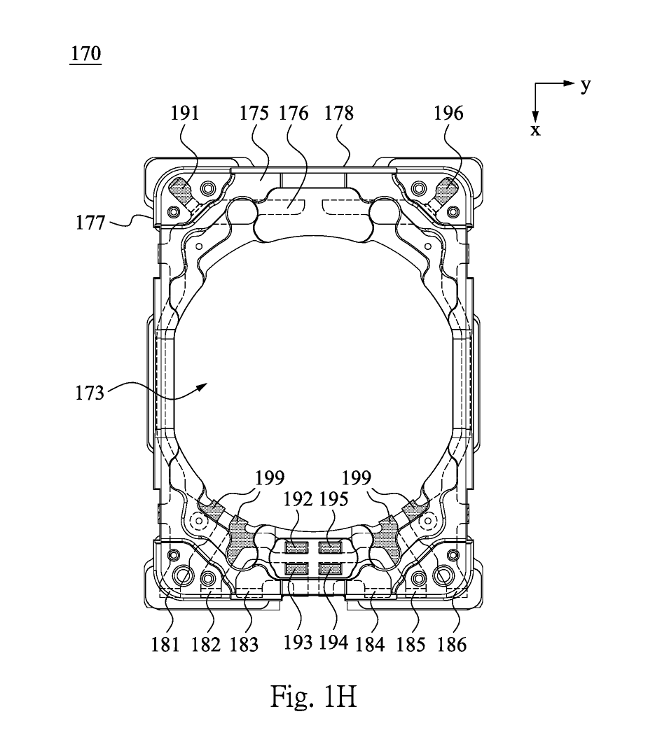

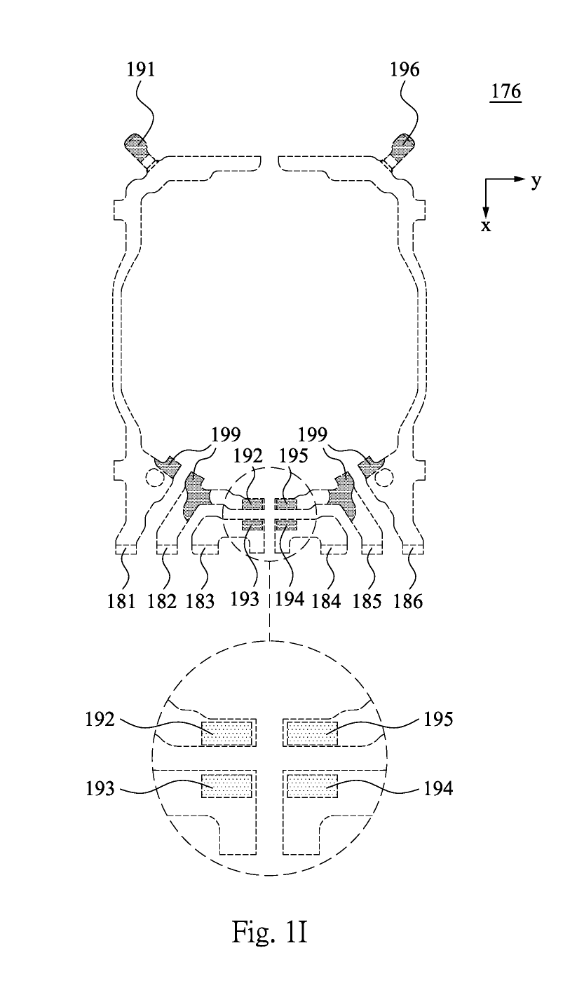

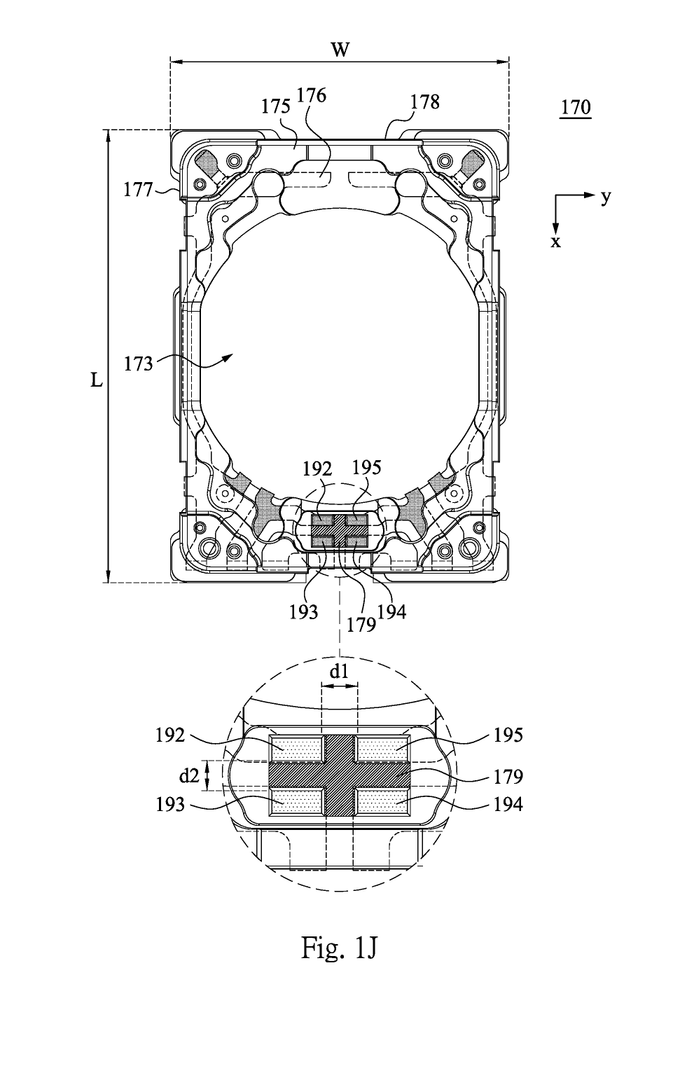

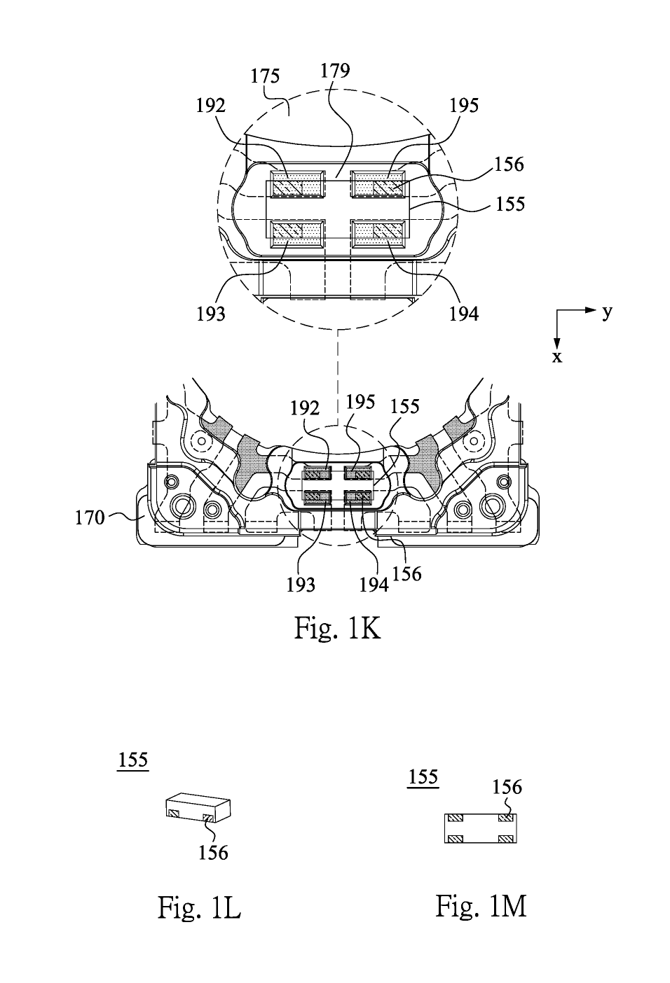

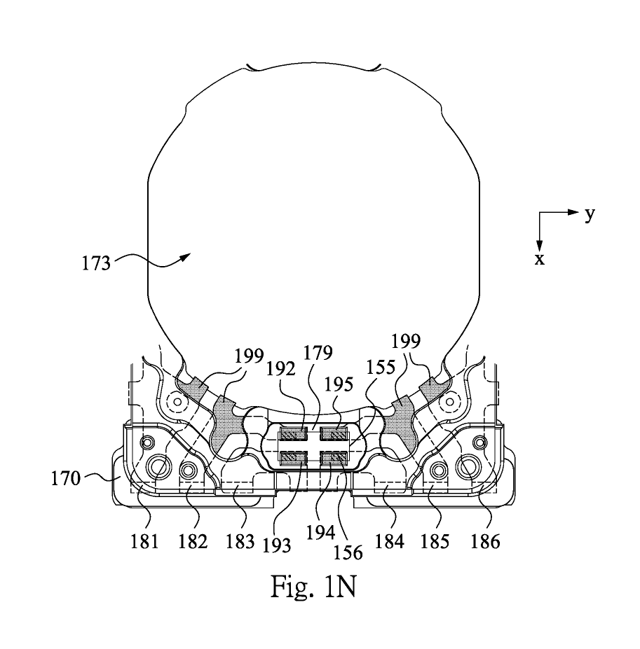

FIG. 1A is an exploded view of a lens driving apparatus 100 with a lens assembly 500 according to the 1st embodiment of the present disclosure, FIG. 1B is another exploded view of the lens driving apparatus 100 with the lens assembly 500 according to the 1st embodiment, and FIG. 1C is a schematic view of the lens driving apparatus 100 with the lens assembly 500 and an image sensor 600 according to the 1st embodiment. In FIG. 1A to FIG. 1C, the lens driving apparatus 100 is for driving the lens assembly 500 and includes a holder 170, a metal cover 110, a carrier 130, at least one detection magnet 150, at least one position detection unit 155, a coil 140 and at least two driving magnets 125.

In FIG. 1C, the lens assembly 500 is assembled with the carrier 130 of the lens driving apparatus 100. The image sensor 600 is for receiving an imaging light from the lens assembly 500 and disposed on a circuit board (not shown herein), which carries the image sensor 600. For clearly describing the characteristics, FIG. 1C shows that the image sensor 600 has not been assembled with the lens assembly 500 and the lens driving apparatus 100 yet.

In FIG. 1A and FIG. 1B, the holder 170 includes a holder opening 173. The metal cover 110 is coupled to the holder 170, that is, the metal cover 110 is disposed correspondingly to the holder 170, and thereby an accommodating space is formed. The metal cover 110 includes a cover opening 113, wherein the cover opening 113 is disposed correspondingly to the holder opening 173. Furthermore, the metal cover 110 may be made of a metal material overall, or made of a metal material with just a part thereof, such as being processed with a metal coating or a metal painting on a surface of a nonmetal material.

The carrier 130 has a central axis (i.e. an optical axis of the lens assembly 500). In the 1st embodiment, a direction z is parallel to the central axis, directions x and y are both orthogonal to the direction z, and the directions x and y are orthogonal to each other. The carrier 130 is for being assembled with the lens assembly 500. The carrier 130 is disposed in the metal cover 110, and the carrier 130 is displaceable relative to the holder 170 along the direction z parallel to the central axis. That is, the lens assembly 500 assembled on the carrier 130 is displaceable relative to the holder 170 along the direction z parallel to the central axis. The coil 140 is wound around and disposed on an outer surface (its reference numeral is omitted) of the carrier 130. The driving magnets 125 are disposed in the metal cover 110 and correspondingly to the coil 140. In the 1st embodiment, a number of the driving magnets 125 is four.

The detection magnet 150 is coupled to an end (its reference numeral is omitted) of the carrier 130, wherein the end of the carrier 130 is close to the holder 170. The position detection unit 155 is disposed on the holder 170 and correspondingly to the detection magnet 150, wherein the position detection unit 155 is for detecting a displacement along the direction z parallel to the central axis of the detection magnet 150.

Furthermore, the detection magnet 150 and the lens assembly 500 are both assembled on the carrier 130, thereby a displacement relative to the holder 170 along the direction z parallel to the central axis of the lens assembly 500 can be obtained from the displacement relative to the holder 170 along the direction z parallel to the central axis of the detection magnet 150 detected by the position detection unit 155. The position detection unit 155 is disposed correspondingly to the detection magnet 150, thereby the lens assembly 500 is allowed to directly move to a focusing position every time, and there is no need to move the lens assembly 500 to an original position before moving to the focusing position so as to reduce the focusing time.

In the 1st embodiment, a number of the detection magnet 150 is two, and a number of the position detection unit 155 is one. Each of the detection magnets 150 has a shape, which is corresponding to the carrier 130, to be coupled to the carrier 130. Specifically, each of the detection magnets 150 is assembled on the carrier 130 in an upright type, that is, a length along the direction z parallel to the central axis of each of the detection magnet 150 is greater than a length along any direction vertical to the central axis (including the directions x and y) thereof. In other embodiments according to the present disclosure (not shown in drawings), a number of the detection magnet may be at least one, a number of the position detection unit may be at least one, and the number of the detection magnet and the number of the position detection unit may be the same or different. Based on the design or production requirements of the lens driving apparatus, the number of the detection magnet may be adjustable. For example, another detection magnet or a compensation element may be allocated on a symmetrical position with respect to a central axis, wherein the compensation element may be without a magnetic property but have the same or a corresponding weight with the detection magnet. Furthermore, a position detection unit may be a Hall sensor, a Hall element, a magnetic field sensor, a photodetector or so on for detecting a change of position or magnetic field. In the 1st embodiment, the position detection unit 155 is a Hall sensor.

FIG. 1D is a side view of the holder 170 of the lens driving apparatus 100 according to the 1st embodiment, FIG. 1E is a schematic view of a lower leaf spring 160 and the holder 170 according to FIG. 1A, FIG. 1F is a schematic view of the holder 170 according to FIG. 1B, and FIG. 1G is a schematic view of the holder 170 and the position detection unit 155 according to the 1st embodiment. In FIG. 1D to FIG. 1G, the holder 170 further includes terminal portions 181, 182, 183, 184, 185, 186 and conductive portions 191, 192, 193, 194, 195, 196, 199. A number of each of the terminal portions 181, 182, 183, 184, 185, 186 is one, a number of each of the conductive portions 191, 192, 193, 194, 195, 196 is one, and a number of the conductive portion 199 is at least one as shown in FIG. 1D to FIG. 1G. Furthermore, the terminal portions 181, 182, 183, 184, 185, 186 and the conductive portions 191, 192, 193, 194, 195, 196, 199 are all made of metal materials.

The terminal portions 181, 182, 183, 184, 185, 186 are extended outward from the holder 170 along the direction z parallel to the central axis. That is, each of the terminal portions 181, 182, 183, 184, 185, 186 is extended at least one of being far from the cover opening 113 and being close to the cover opening 113. An outward extending section (its reference numeral is omitted) of each of the terminal portions 181, 182, 183, 184, 185, 186 may have at least one of a straight strip shape, a curved shape, an arc shape and a hemispherical shape. The outward extending sections of the terminal portions 181, 182, 183, 184, 185, 186 may have the same or different shapes and be extended in the same or different directions. The outward extending section of each of the terminal portions 181, 182, 183, 184, 185, 186 may be directly electrically connected to other parts of the lens driving apparatus 100, and may be directly electronically connected to a circuit board of an electronic device configured with a photographing module (for example, the circuit board carrying the image sensor 600). In the 1st embodiment, the terminal portions 181, 182, 183, 184, 185, 186 are all extended far from the cover opening 113 and directly electronically connected to the circuit board carrying the image sensor 600.

The conductive portions 191, 192, 193, 194, 195, 196, 199 are exposed on a surface (its reference numeral is omitted) of the holder 170, wherein at least four of the conductive portions 191, 192, 193, 194, 195, 196, 199 (specifically, the conductive portions 192, 193, 194, 195) are disposed correspondingly to the position detection unit 155. Therefore, the lens driving apparatus 100 being a close-loop type is advantageous to a feasibility of the fast focusing function and the compact size thereof. Comparing a conventional lens driving apparatus requiring more circuit boards or flexible printed circuit boards, the lens driving apparatus 100 according to the present disclosure could save or reduce the required circuit boards, and it is favorable for decreasing the manufacturing cost and omitting additional production steps. Each of the conductive portions 191, 192, 193, 194, 195, 196, 199 may be directly electrically connected to other parts of the lens driving apparatus 100, may be directly electronically connected to a circuit board of an electronic device configured with a photographing module, or may be exposed on the surface of the holder 170 only. In the 1st embodiment, the conductive portions 192, 193, 194, 195 are disposed correspondingly to the position detection unit 155. That is, a number of the conductive portions which are disposed correspondingly to the position detection unit 155 is four. In other embodiments according to the present disclosure (not shown in drawings), at least five of the conductive portions may be disposed correspondingly to the position detection unit. That is, a number of the conductive portions which are disposed correspondingly to the position detection unit may be at least five.

Specifically, the four conductive portions 192, 193, 194, 195 are respectively disposed correspondingly to and directly electrically connected to four pins 156 of the position detection unit 155. Furthermore, the four pins 156 of the position detection unit 155 may be directly electrically connected to the four conductive portions 192, 193, 194, 195, respectively, by manners of welding, soldering, hot stamping and so on, thereby the position detection unit 155 is disposed on the holder 170. In the 1st embodiment, the position detection unit 155 is disposed on the holder 170 via the four pins 156 thereof being respectively directly electrically connected to the four conductive portions 192, 193, 194, 195 by the manner of welding.

In FIG. 1G, the four conductive portions 192, 193, 194, 195 may be arranged as a grid array of two rows and two columns. Therefore, the conduction portions arranged as a grid array, which are disposed correspondingly to an integrated circuit in a small outline or a small package, is allowed to be designed on the lens driving apparatus 100, thereby this kind of the integrated circuit can be more effectively applied in the lens driving apparatus 100. Comparing a conventional lens driving apparatus requiring more circuit boards, the lens driving apparatus 100 according to the present disclosure could save or reduce the required circuit boards and the corresponding mechanical parts, and it is favorable for the lens driving apparatus 100 to have a required compact size. In other embodiments according to the present disclosure (not shown in drawings), at least five of the conductive portions may be disposed correspondingly to the position detection unit. The at least five of the conductive portions may be regularly arranged as a grid array of two rows and three columns, three rows and two columns, three rows and three columns, or more rows and more columns, wherein four of the at least five of the conductive portions are arranged as a sub-grid array of two rows and two columns. The at least five of the conductive portions may be incompletely regularly arranged, wherein four of the at least five of the conductive portions are arranged as a grid array of two rows and two columns.

FIG. 1H is a schematic view of a plastic part 175 and conductive parts 176 of the holder 170 according to the 1st embodiment, and FIG. 1I is a schematic view of the conductive parts 176 of the holder 170 according to the 1st embodiment. In FIG. 1G to FIG. 1I, the holder 170 includes the plastic part 175 and at least one conductive part 176. The plastic part 175 is made of a plastic material. A number of the conductive part 176 is six, wherein the conductive parts 176 are made of metal materials, and any one of the conductive parts 176 may be curved along the direction z parallel to the central axis. The conductive parts 176 include the terminal portions 181, 182, 183, 184, 185, 186 and the conductive portions 191, 192, 193, 194, 195, 196, 199. The terminal portions 181, 182, 183, 184, 185, 186 and the conductive portions 191, 192, 193, 194, 195, 196, 199 may be embedded in the holder 170 by an insert molding method. Specifically, the terminal portions 181, 182, 183, 184, 185, 186 and the conductive portions 191, 192, 193, 194, 195, 196, 199 may be joined with the plastic part 175 by the insert molding method, and exposed on the plastic part 175. Therefore, it is favorable for reducing the assembling tolerances between the plastic part 175 and the conductive parts 176, decreasing the assembling steps for the lens driving apparatus 100, and thereby increasing the production efficiency.

In FIG. 1H and FIG. 1I, the four conductive portions 192, 193, 194, 195 are respectively electrically connected to four of the terminal portions 181, 182, 183, 184, 185, 186 (specifically, the four terminal portions 182, 183, 184, 185), and the four conductive portions 192, 193, 194, 195 are closer to the holder opening 173 than the four terminal portions 182, 183, 184, 185 to the holder opening 173. Therefore, before the terminal portions being welded, the conductive portions designed closer to the holder opening than the terminal portions are welded and thereby affected less. It is also favorable for increasing the production efficiency by welding in order from being close to the holder opening 173 to being far from the holder opening 173. In other embodiments according to the present disclosure (not shown in drawings), at least five of the conductive portions may be disposed correspondingly to the position detection unit, wherein the at least five conductive portions are respectively electrically connected to at least five of terminal portions, and the at least five conductive portions are closer to a holder opening than the at least five terminal portions to the holder opening.

In the 1st embodiment, the four pins 156 of the position detection unit 155 are directly electrically connected to the four conductive portions 192, 193, 194, 195, respectively. The conductive portion 192 and the terminal portion 182 are located on the same one of the conductive parts 176 and thereby directly electrically connected to each other. The conductive portion 193 and the terminal portion 183 are located on the same one of the conductive parts 176 and thereby directly electrically connected to each other. The conductive portion 194 and the terminal portion 184 are located on the same one of the conductive parts 176 and thereby directly electrically connected to each other. The conductive portion 195 and the terminal portion 185 are located on the same one of the conductive parts 176 and thereby directly electrically connected to each other. The four terminal portions 182, 183, 184, 185 are directly electrically connected to a circuit board of an electronic device. Thus, the displacement relative to the holder 170 along the direction z parallel to the central axis of the detection magnet 150 can be converted and obtained from an output signal of the position detection unit 155.

In FIG. 1E to FIG. 1H, the conductive portions 191, 192, 193, 194, 195, 196, 199 may be not extended outward from the holder 170 along the direction z parallel to the central axis. Therefore, the conductive portions 191, 192, 193, 194, 195, 196, 199 of the conductive parts 176, which are made of metal materials, embedded in and exposed on the holder 170, are advantageous in maintaining the conductive parts 176 with mainly planar shapes, so as to avoid overly complicated shapes and reduce the defect rate of the holder 170. In other embodiments according to the present disclosure (not shown in drawings), conductive portions are disposed correspondingly to a position detection unit, and the conductive portions may be extended outward from a holder along the direction z parallel to the central axis or along other directions.

FIG. 1J is a schematic view of the four conductive portions 192, 193, 194, 195 of the holder 170 according to the 1st embodiment. FIG. 1K is a schematic view of the four conductive portions 192, 193, 194, 195 of the holder 170 and the position detection unit 155 according to the 1st embodiment, wherein FIG. 1K also shows the four conductive portions 192, 193, 194, 195 being directly electrically connected to the position detection unit 155. In FIG. 1G, FIG. 1J and FIG. 1K, the surface of the holder 170 may include a cross pattern 179 corresponding to or among the four conductive portions 192, 193, 194, 195. Specifically, the plastic part 175 of the holder 170 includes the cross pattern 179 (the cross pattern 179 of the plastic part 175 is marked with slash lines in FIG. 1J). The cross pattern 179 enables the conductive parts 176 to be exposed, and form and be separated into the four conductive portions 192, 193, 194, 195. Each of the four conductive portions 192, 193, 194, 195 is in a rectangular shape and has the same or similar dimension. An entirety of the four conductive portions 192, 193, 194, 195 has a length in the direction x, which is greater than a length in the direction x of the position detection unit 155, and it is favorable for the position detection unit 155 with the four pins 156 being respectively directly electrically connected to the four conductive portions 192, 193, 194, 195 so as to be disposed on the holder 170. When a first width of the cross pattern 179 is d1, and a second width of the cross pattern 179 is d2, the following conditions may be satisfied: 0.05 mm<d1<0.8 mm; and 0.05 mm<d2<0.8 mm. It is that two stripe structures vertical to each other of the cross pattern 179 respectively have the first width d1 and the second width d2. Therefore, it is favorable for reducing short circuit occurrences after welding process by properly arranging the first width d1 and the second width d2 of the cross pattern 179 among the conductive portions 192, 193, 194, 195. Preferably, the following conditions may be satisfied: 0.15 mm<d1<0.55 mm; and 0.15 mm<d2<0.55 mm. In other embodiments according to the present disclosure (not shown in drawings), two stripe structures of a cross pattern are vertical to each other, wherein each of the two stripe structures may be in a straight stripe shape (such as the cross pattern 179 in the 1st embodiment), each of the two stripe structures may be in an unstraight stripe shape, and the cross pattern may be asymmetric with respect to an intersection position thereof.

FIG. 1L is a three-dimensional view of the position detection unit 155 according to the 1st embodiment, FIG. 1M is a bottom view of the position detection unit 155 according to the 1st embodiment, and FIG. 1N is a schematic view of the terminal portions 181, 182, 183, 184, 185, 186 of the holder 170 according to the 1st embodiment. In FIG. 1G, FIG. 1K to FIG. 1N, the position detection unit 155 may be in a small outline non-leaded package (SON). Therefore, the position detection unit 155 being an integrated circuit in a small outline or a small package is advantageous in welding with the conductive portions 192, 193, 194, 195 so as to effectively reduce the volume of the lens driving apparatus 100 and not to affect the welding process. In the 1st embodiment, the position detection unit 155 is in a small outline non-leaded package with the four pins 156. In other embodiments according to the present disclosure (not shown in drawings), without affecting a volume of a lens driving apparatus, a position detection unit thereof may be in a package with at least four pins of very small outline no lead (VSON), small outline package (SOP), small outline or small package.

In FIG. 1G, when a thickness of the position detection unit 155 is h, which is a length along the direction z parallel to the central axis of the position detection unit 155, the following condition may be satisfied: h<1.0 mm. Therefore, the position detection unit 155 in a smaller package is advantageous in being applied in the holder 170. If a position detection unit has an overly large thickness, it affects the focusing clarity of the photographing module.

In FIG. 1H and FIG. 1K, the holder 170 may have a rectangular shape, wherein the rectangular shape of the holder 170 includes two long sides 177 and two short sides 178. That is, the holder 170 may be substantially rectangular in shape. The position detection unit 155 and the terminal portions 181, 182, 183, 184, 185, 186 may be close to one of the short sides 178 of the rectangular shape. Furthermore, the conductive portion 191 and the terminal portion 181 are located on the same one of the conductive parts 176 and thereby directly electrically connected to each other. The conductive portion 192 and the terminal portion 182 are located on the same one of the conductive parts 176 and thereby directly electrically connected to each other. The conductive portion 193 and the terminal portion 183 are located on the same one of the conductive parts 176 and thereby directly electrically connected to each other. The conductive portion 194 and the terminal portion 184 are located on the same one of the conductive parts 176 and thereby directly electrically connected to each other. The conductive portion 195 and the terminal portion 185 are located on the same one of the conductive parts 176 and thereby directly electrically connected to each other. The conductive portion 196 and the terminal portion 186 are located on the same one of the conductive parts 176 and thereby directly electrically connected to each other. Therefore, the conductive portions 191, 192, 193, 194, 195, 196 could be prevented from additional unneeded lengths. It is favorable for the conductive parts 176 with a small proportion of the holder 170 to be covered by more plastic molding material, so as to maintain the dimensional accuracy of the holder 170.

In FIG. 1J, when a length of each of the long sides 177 of the rectangular shape is L, and a length of each of short sides 178 of the rectangular shape is W, the following condition may be satisfied: 1.20<L/W<1.80. Therefore, the rectangular shape of the holder 170 satisfying the aforementioned condition is advantageous in providing more margins to change the driving magnets. Driving magnets in rectangular shapes (different from the four driving magnets 125 in nonrectangular shapes respectively received in four corners of the holder 170 in FIG. 1A) could be disposed correspondingly to the long sides 177 and the short sides 178 of the holder 170 so as to provide a better driving efficiency. Preferably, the following condition may be satisfied: 1.30<L/W<1.50.

In FIG. 1A and FIG. 1B, one of the two detection magnets 150 (the detection magnet 150 toward a positive direction of the direction x, specifically) and the position detection unit 155 may be arranged along the direction z parallel to the central axis. Therefore, the arrangement of the detection magnet 150 and the position detection unit 155 is advantageous in saving additional mechanical parts, so as to reduce the assembling and welding steps, and effectively decrease cost.

FIG. 1O is a schematic view of the carrier 130 and the detection magnets 150 according to FIG. 1B. In FIG. 1B and FIG. 1O, the carrier 130 may include at least one notch portion 138 accommodating the detection magnet 150, and an opening (its reference numeral is omitted) of the notch portion 138 faces the holder 170. Therefore, the opening of the notch portion 138 facing the position detection unit 155 is advantageous in enhancing the displacement detecting efficiency. In the 1st embodiment, a number of the notch portion 138 is two, and the two notch portions 138 respectively accommodate the two detection magnets 150.

In FIG. 1O, each of the notch portions 138 may include a plurality of rib structures 139, and the rib structures 139 are for contacting the detection magnets 150 and fixedly disposing the detection magnets 150 on the carrier 130. Therefore, the design of the rib structures 139 is advantageous in increasing the firmness of the detection magnets 150 being fixedly accommodated in the notch portions 138. Moreover, a plurality of gaps (their reference numerals are omitted) are formed and separated between an inner wall (its reference numeral is omitted) of each of the notch portions 138 and the corresponding one of the detection magnets 150, and a glue material may be dispensed into the gaps as needed so as to increase the firmness therebetween.

In FIG. 1A, FIG. 1B and FIG. 1E, the lens driving apparatus 100 may further include at least one upper leaf spring 120 and at least one lower leaf spring 160, wherein the upper leaf spring 120 and the lower leaf spring 160 are both connected to the carrier 130 and arranged along the direction z parallel to the central axis. The lower leaf spring 160 is disposed on the end of the carrier 130 close to the holder 170, and the upper leaf spring 120 is disposed on the other end (its reference numeral is omitted) of the carrier 130 far from the holder 170. Thus, the carrier 130 and the lens assembly 500 are carried to be displaced along the direction z parallel to the central axis, that is, the upper leaf spring 120 and the lower leaf spring 160 provide the carrier 130 and the lens assembly 500 with a degree of freedom along the direction z parallel to the central axis. In the 1st embodiment, a number of the upper leaf spring 120 is one, a number of the lower leaf spring 160 is two, and the upper leaf spring 120 and the lower leaf springs 160 are all made of metal materials. In addition, the upper leaf spring and the lower leaf spring herein are the idiomatic expressions in the art, wherein the upper leaf spring indicates a leaf spring, which is far from the holder (i.e. close to an object side of a lens assembly), the lower leaf spring indicates another leaf spring, which is close to the holder (i.e. close to an image side of the lens assembly), and the upper leaf spring and the lower leaf spring do not indicate being disposed at an absolutely upper position and an absolutely lower position respectively.

Each of the lower leaf springs 160 may include a connecting section 164, and the connecting section 164 is directly electrically connected to another two of the conductive portions 191, 192, 193, 194, 195, 196, 199 (the conductive portions 191, 196, specifically) of the holder 170. Therefore, the conductive parts 176 including the conductive portions 191, 196, which are respectively corresponding to the two lower leaf springs 160, are advantageous to design the required circuit for auto-focusing in a limited volume. In the 1st embodiment, the number of the lower leaf spring 160 is two, each of the lower leaf springs 160 includes the connecting section 164, and the two connecting sections 164 are respectively connected to the conductive portions 191, 196. Accordingly, current in the coil 140 could be induced by an external driving current, wherein a conductive path of the external driving current is formed by the directly electrical connection between the two connecting sections 164 and the conductive portions 191, 196 respectively, the directly electrical connection between the conductive portions 191, 196 and the terminal portions 181, 186 respectively, and the directly electrical connection between the terminal portions 181, 186 and the circuit board of the electronic device.

Specifically, a central section (its reference numeral is omitted) of each of the lower leaf springs 160 is connected to the carrier 130, and the connecting section 164 located on one end of each of the lower leaf springs 160 is connected to one of the conductive portions 191, 196 of the holder 170. Accordingly, the carrier 130 and the lens assembly 500 could be carried to be displaced relative to the holder 170 along the direction z parallel to the central axis by the lower leaf springs 160.

The data of the aforementioned parameters of the lens driving apparatus 100 according to the 1st embodiment of the present disclosure are listed in the following Table 1, wherein the parameters are also shown as FIG. 1G and FIG. 1J.

TABLE 1
1st Embodiment

| | | | |
|---|---|---|---|
| d1 (mm) | 0.24 | W (mm) | 5.62 |
| d2 (mm) | 0.2 | L/W | 1.34 |
| L (mm) | 7.52 | h (mm) | 0.2188 |

### 2nd Embodiment

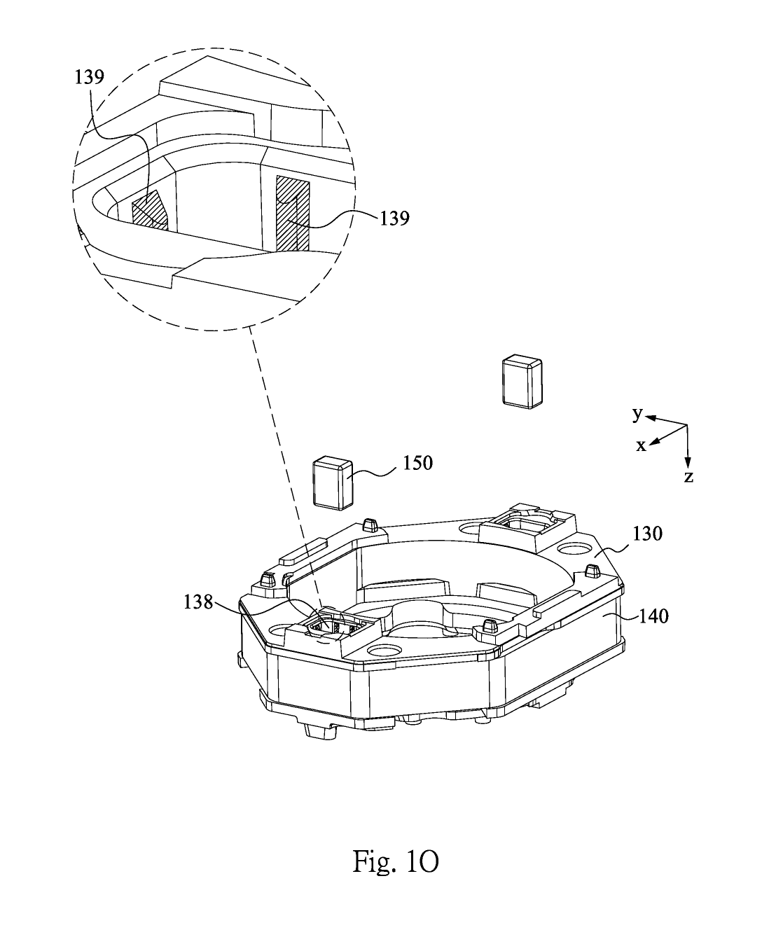

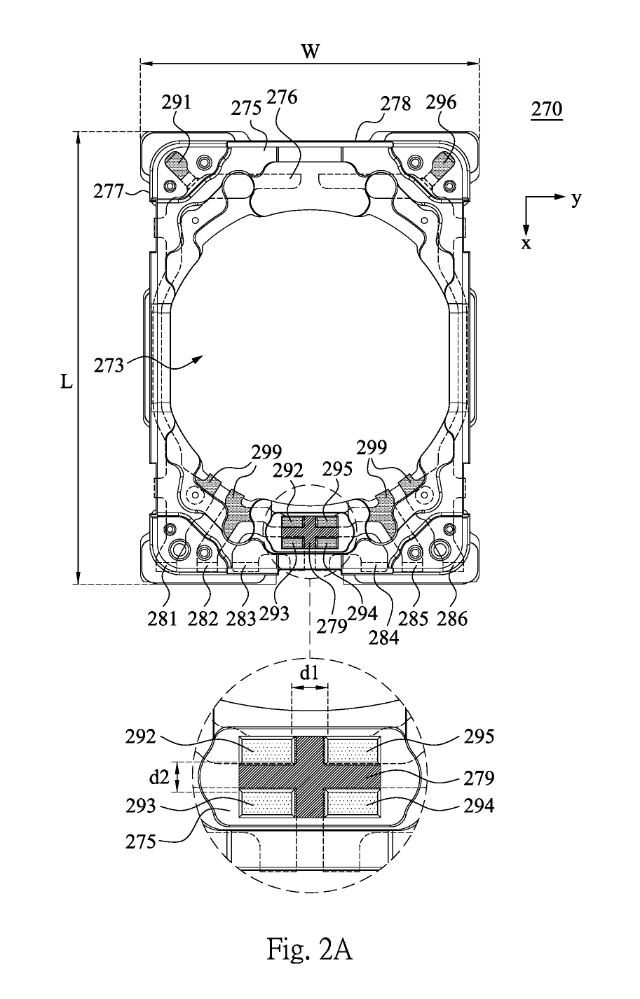

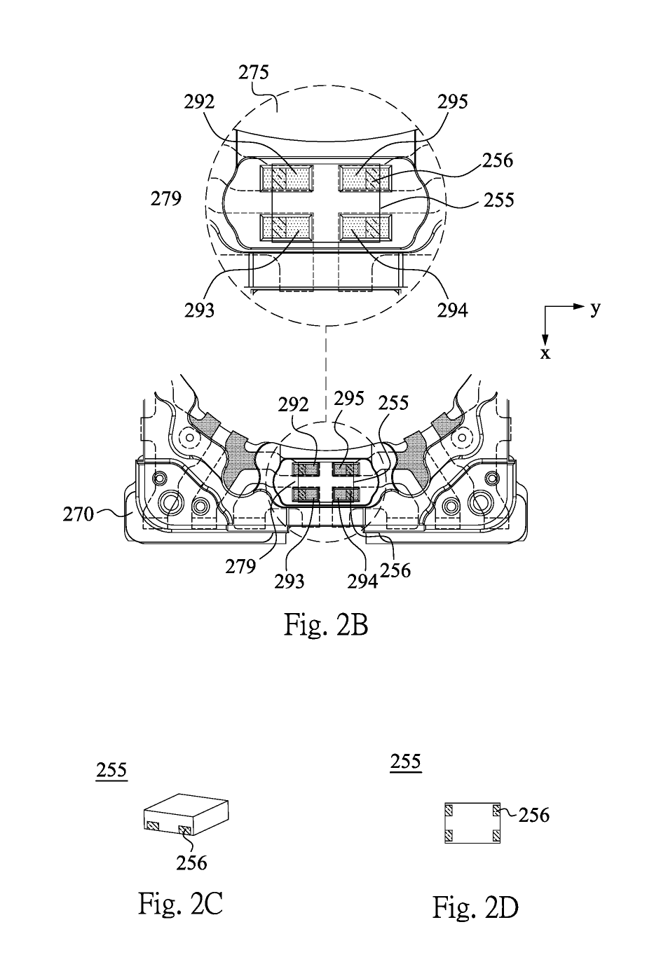

FIG. 2A is a schematic view of a plastic part 275 and conductive parts 276 of a holder 270 of a lens driving apparatus according to the 2nd embodiment of the present disclosure. In FIG. 1A and FIG. 2A, the lens driving apparatus according to the 2nd embodiment of the present disclosure is for driving a lens assembly and includes a holder 270, a metal cover, a carrier, at least one detection magnet, at least one position detection unit 255, a coil and at least two driving magnets. The metal cover, the carrier, the detection magnets, the coil and the driving magnets (i.e. the holder 270 and the position detection unit 255 being excluded) of the lens driving apparatus according to the 2nd embodiment can be respectively the same as the metal cover 110, the carrier 130, the detection magnets 150, the coil 140 and the driving magnets 125 of the lens driving apparatus 100 according to the aforementioned 1st embodiment. The other details of the lens driving apparatus 100 have been described in the foregoing paragraphs of the 1st embodiment and will not be described again herein.

FIG. 2B is a schematic view of conductive portions 292, 293, 294, 295 of the holder 270 and the position detection unit 255 according to the 2nd embodiment, wherein FIG. 2B also shows the four conductive portions 292, 293, 294, 295 being directly electrically connected to the position detection unit 255. FIG. 2C is a three-dimensional view of the position detection unit 255 according to the 2nd embodiment, and FIG. 2D is a bottom view of the position detection unit 255 according to the 2nd embodiment. In FIG. 1A and FIG. 2A to FIG. 2D, the holder 270 includes a holder opening 273. The metal cover is coupled to the holder 270 and includes a cover opening, wherein the cover opening is disposed correspondingly to the holder opening 273. The carrier has a central axis (i.e. an optical axis of the lens assembly), wherein a direction z is parallel to the central axis, directions x and y are both orthogonal to the direction z, and the directions x and y are orthogonal to each other. The carrier is for being assembled with the lens assembly. The carrier is disposed in the metal cover, and the carrier is displaceable relative to the holder 270 along the direction z parallel to the central axis. The detection magnets are coupled to an end of the carrier, wherein the end of the carrier is close to the holder 270. The position detection unit 255 is disposed on the holder 270 and correspondingly to the detection magnets, wherein the position detection unit 255 is for detecting a displacement along the direction z parallel to the central axis of the detection magnets. The coil is wound around and disposed on an outer surface of the carrier. The driving magnets are disposed in the metal cover and correspondingly to the coil.

The holder 270 further includes terminal portions 281, 282, 283, 284, 285, 286 and conductive portions 291, 292, 293, 294, 295, 296, 299. A number of each of the terminal portions 281, 282, 283, 284, 285, 286 is one, a number of each of the conductive portions 291, 292, 293, 294, 295, 296 is one, and a number of the conductive portion 299 is at least one as shown in FIG. 2A. Furthermore, the terminal portions 281, 282, 283, 284, 285, 286 and the conductive portions 291, 292, 293, 294, 295, 296, 299 are all made of metal materials.

The terminal portions 281, 282, 283, 284, 285, 286 are extended outward from the holder 270 along the direction z parallel to the central axis. The conductive portions 291, 292, 293, 294, 295, 296, 299 are exposed on a surface of the holder 270, wherein four of the conductive portions 291, 292, 293, 294, 295, 296, 299 (specifically, the conductive portions 292, 293, 294, 295) are disposed correspondingly to the position detection unit 255. The position detection unit 255 is disposed on the holder 270 via four pins 256 thereof being respectively directly electrically connected to the four conductive portions 292, 293, 294, 295 by the manner of welding. The four conductive portions 292, 293, 294, 295 are arranged as a grid array of two rows and two columns.

In FIG. 2A, the holder 270 includes a plastic part 275 and six conductive parts 276, wherein the plastic part 275 is made of a plastic material, and the conductive parts 276 are made of metal materials. The conductive parts 276 include the terminal portions 281, 282, 283, 284, 285, 286 and the conductive portions 291, 292, 293, 294, 295, 296, 299. The terminal portions 281, 282, 283, 284, 285, 286 and the conductive portions 291, 292, 293, 294, 295, 296, 299 are embedded in the holder 270 by an insert molding method. Specifically, the terminal portions 281, 282, 283, 284, 285, 286 and the conductive portions 291, 292, 293, 294, 295, 296, 299 are joined with the plastic part 275 by the insert molding method, and exposed on the plastic part 275. The conductive portions 291, 292, 293, 294, 295, 296, 299 are not extended outward from the holder 270 along the direction z parallel to the central axis.

The four conductive portions 292, 293, 294, 295 are respectively electrically connected to four of the terminal portions 281, 282, 283, 284, 285, 286 (specifically, the four terminal portions 282, 283, 284, 285), and the four conductive portions 292, 293, 294, 295 are closer to the holder opening 273 than the four terminal portions 282, 283, 284, 285 to the holder opening 273.

In FIG. 2A to FIG. 2D, four pins 256 of the position detection unit 255 are respectively directly electrically connected to the four conductive portions 292, 293, 294, 295. The conductive portion 292 and the terminal portion 282 are located on the same one of the conductive parts 276 and thereby directly electrically connected to each other. The conductive portion 293 and the terminal portion 283 are located on the same one of the conductive parts 276 and thereby directly electrically connected to each other. The conductive portion 294 and the terminal portion 284 are located on the same one of the conductive parts 276 and thereby directly electrically connected to each other. The conductive portion 295 and the terminal portion 285 are located on the same one of the conductive parts 276 and thereby directly electrically connected to each other. The four terminal portions 282, 283, 284, 285 are directly electrically connected to a circuit board of an electronic device. Thus, the displacement relative to the holder 270 along the direction z parallel to the central axis of the detection magnet can be converted and obtained from an output signal of the position detection unit 255.

The position detection unit 255 is in a small outline non-leaded package with the four pins 256. The surface of the holder 270 includes a cross pattern 279 corresponding to or among the four conductive portions 292, 293, 294, 295. Specifically, the plastic part 275 of the holder 270 includes the cross pattern 279 (the cross pattern 279 of the plastic part 275 is marked with slash lines in FIG. 2A), and each of two stripe structures vertical to each other of the cross pattern 279 is in a straight stripe shape. The cross pattern 279 enables the conductive parts 276 to be exposed, and form and be separated into the four conductive portions 292, 293, 294, 295. Each of the four conductive portions 292, 293, 294, 295 is in a rectangular shape and has the same or similar dimension. An entirety of the four conductive portions 292, 293, 294, 295 has a length in the direction y, which is greater than a length in the direction y of the position detection unit 255, and it is favorable for the position detection unit 255 with the four pins 256 being respectively directly electrically connected to the four conductive portions 292, 293, 294, 295 so as to be disposed on the holder 270.

The holder 270 has a rectangular shape, wherein the rectangular shape of the holder 270 includes two long sides 277 and two short sides 278. That is, the holder 270 is substantially rectangular in shape. The position detection unit 255 and the terminal portions 281, 282, 283, 284, 285, 286 are close to one of the short sides 278 of the rectangular shape.

In FIG. 1A and FIG. 2A, the lens driving apparatus of the 2nd embodiment further includes at least one upper leaf spring and at least one lower leaf spring, wherein the upper leaf spring and the lower leaf spring are both connected to the carrier and arranged along the direction z parallel to the central axis. Thus, the carrier and the lens assembly are carried to be displaced along the direction z parallel to the central axis. In the 2nd embodiment, a number of the lower leaf spring is two, each of the lower leaf springs includes a connecting section, and the two connecting sections are respectively connected to the conductive portions 291, 296. Furthermore, the conductive portion 291 and the terminal portion 281 are located on the same one of the conductive parts 276 and thereby directly electrically connected to each other. The conductive portion 296 and the terminal portion 286 are located on the same one of the conductive parts 276 and thereby directly electrically connected to each other. Accordingly, current in the coil could be induced by an external driving current, wherein a conductive path of the external driving current is formed by the directly electrical connection between the two connecting sections and the conductive portions 291, 296 respectively, the directly electrical connection between the conductive portions 291, 296 and the terminal portions 281, 286 respectively, and the directly electrical connection between the terminal portions 281, 286 and the circuit board of the electronic device.

The data of the parameters of the lens driving apparatus according to the 2nd embodiment of the present disclosure are listed in the following Table 2, wherein the parameters are also shown as FIG. 2A. The definitions of these parameters shown in Table 2 are the same as those stated in the 1st embodiment with corresponding values in the 2nd embodiment.

TABLE 2
2nd Embodiment

| | | | |
|---|---|---|---|
| d1 (mm) | 0.24 | W (mm) | 5.62 |
| d2 (mm) | 0.2 | L/W | 1.34 |
| L (mm) | 7.52 | h (mm) | 0.2188 |

### 3rd Embodiment

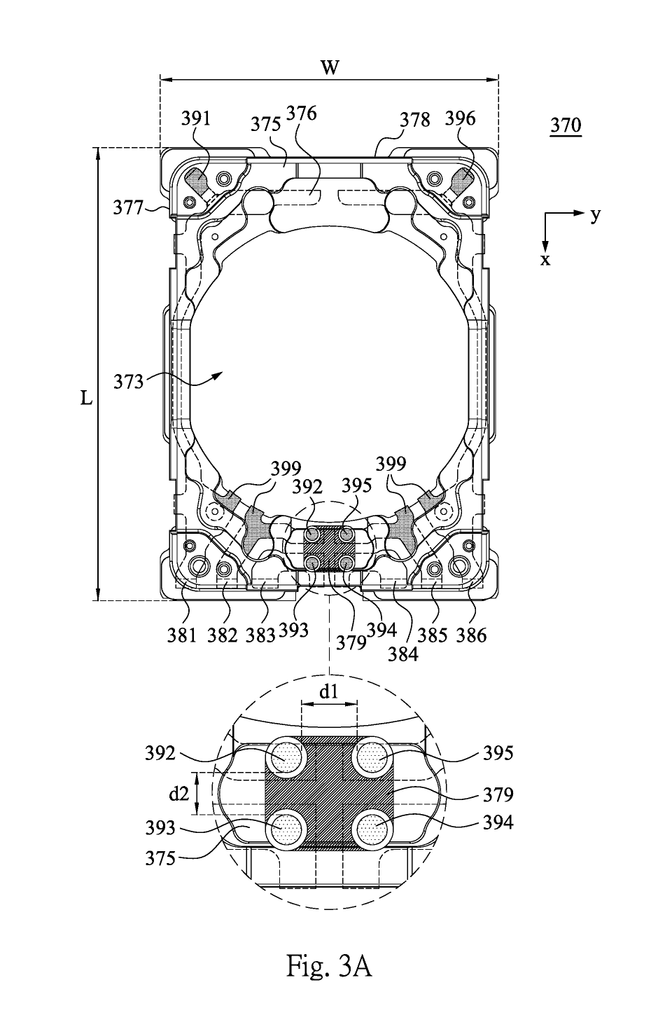

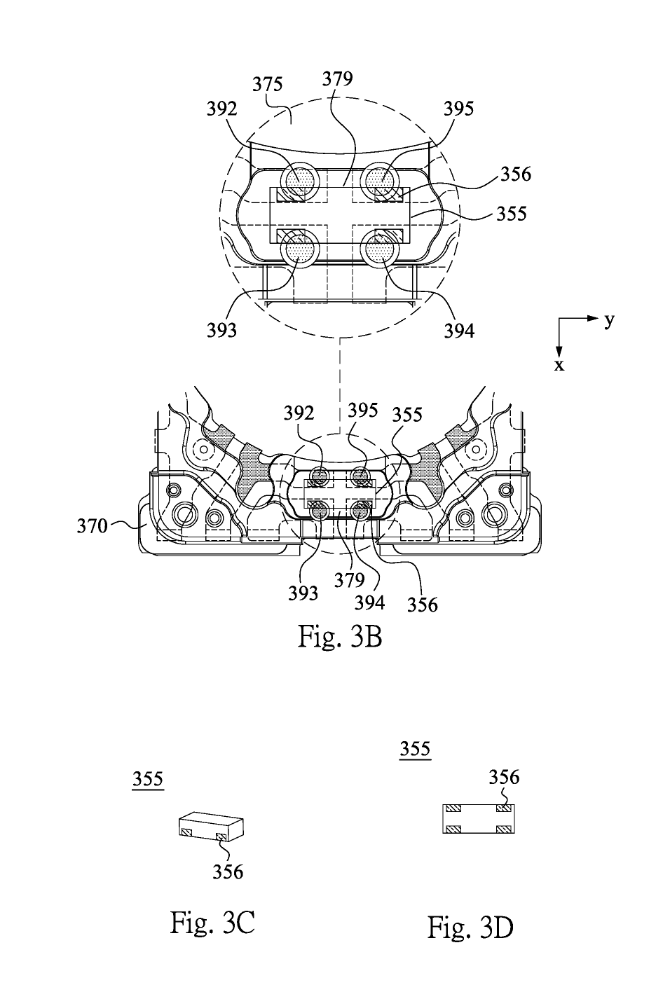

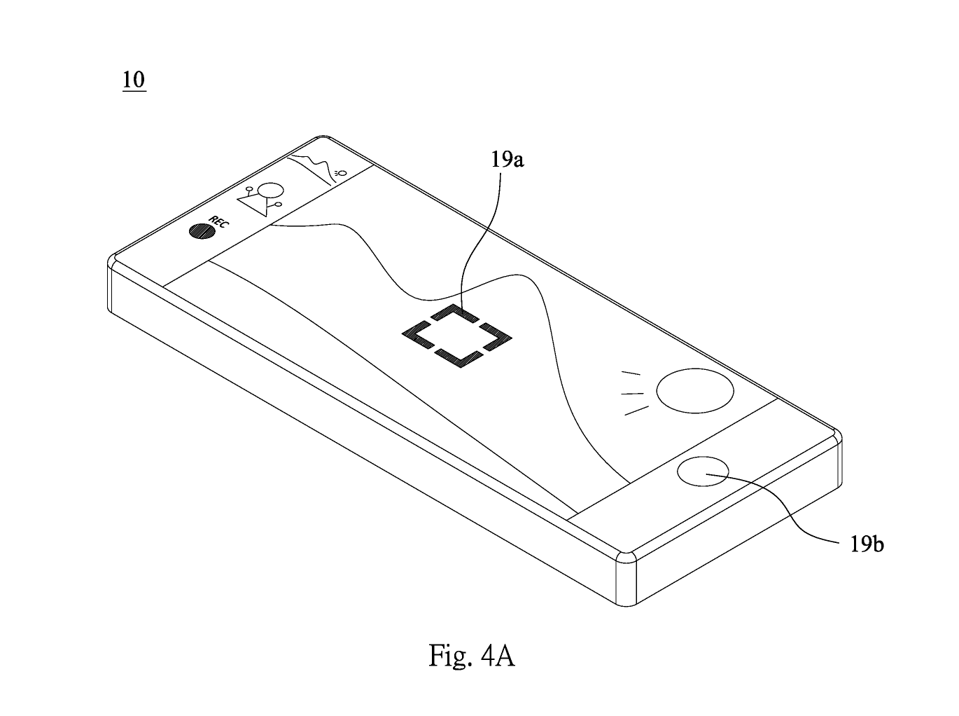

FIG. 3A is a schematic view of a plastic part 375 and conductive parts 376 of a holder 370 of a lens driving apparatus according to the 3rd embodiment of the present disclosure. In FIG. 1A and FIG. 3A, the lens driving apparatus according to the 3rd embodiment of the present disclosure is for driving a lens assembly and includes a holder 370, a metal cover, a carrier, at least one detection magnet, at least one position detection unit 355, a coil and at least two driving magnets. The metal cover, the carrier, the detection magnets, the coil and the driving magnets (i.e. the holder 370 and the position detection unit 355 being excluded) of the lens driving apparatus according to the 3rd embodiment can be respectively the same as the metal cover 110, the carrier 130, the detection magnets 150, the coil 140 and the driving magnets 125 of the lens driving apparatus 100 according to the aforementioned 1st embodiment. The other details of the lens driving apparatus 100 have been described in the foregoing paragraphs of the 1st embodiment and will not be described again herein.

FIG. 3B is a schematic view of conductive portions 392, 393, 394, 395 of the holder 370 and the position detection unit 355 according to the 3rd embodiment, wherein FIG. 3B also shows the four conductive portions 392, 393, 394, 395 being directly electrically connected to the position detection unit 355. FIG. 3C is a three-dimensional view of the position detection unit 355 according to the 3rd embodiment, and FIG. 3D is a bottom view of the position detection unit 355 according to the 3rd embodiment. In FIG. 1A and FIG. 3A to FIG. 3D, the holder 370 includes a holder opening 373. The metal cover is coupled to the holder 370 and includes a cover opening, wherein the cover opening is disposed correspondingly to the holder opening 373. The carrier has a central axis (i.e. an optical axis of the lens assembly), wherein a direction z is parallel to the central axis, directions x and y are both orthogonal to the direction z, and the directions x and y are orthogonal to each other. The carrier is for being assembled with the lens assembly. The carrier is disposed in the metal cover, and the carrier is displaceable relative to the holder 370 along the direction z parallel to the central axis. The detection magnets are coupled to an end of the carrier, wherein the end of the carrier is close to the holder 370. The position detection unit 355 is disposed on the holder 370 and correspondingly to the detection magnets, wherein the position detection unit 355 is for detecting a displacement along the direction z parallel to the central axis of the detection magnets. The coil is wound around and disposed on an outer surface of the carrier. The driving magnets are disposed in the metal cover and correspondingly to the coil.

The holder 370 further includes terminal portions 381, 382, 383, 384, 385, 386 and conductive portions 391, 392, 393, 394, 395, 396, 399. A number of each of the terminal portions 381, 382, 383, 384, 385, 386 is one, a number of each of the conductive portions 391, 392, 393, 394, 395, 396 is one, and a number of the conductive portion 399 is at least one as shown in FIG. 3A. Furthermore, the terminal portions 381, 382, 383, 384, 385, 386 and the conductive portions 391, 392, 393, 394, 395, 396, 399 are all made of metal materials.

The terminal portions 381, 382, 383, 384, 385, 386 are extended outward from the holder 370 along the direction z parallel to the central axis. The conductive portions 391, 392, 393, 394, 395, 396, 399 are exposed on a surface of the holder 370, wherein four of the conductive portions 391, 392, 393, 394, 395, 396, 399 (specifically, the conductive portions 392, 393, 394, 395) are disposed correspondingly to the position detection unit 355. The position detection unit 355 is disposed on the holder 370 via four pins 356 thereof being respectively directly electrically connected to the four conductive portions 392, 393, 394, 395 by the manner of welding. The four conductive portions 392, 393, 394, 395 are arranged as a grid array of two rows and two columns.

In FIG. 3A, the holder 370 includes a plastic part 375 and six conductive parts 376, wherein the plastic part 375 is made of a plastic material, and the conductive parts 376 are made of metal materials. The conductive parts 376 include the terminal portions 381, 382, 383, 384, 385, 386 and the conductive portions 391, 392, 393, 394, 395, 396, 399. The terminal portions 381, 382, 383, 384, 385, 386 and the conductive portions 391, 392, 393, 394, 395, 396, 399 are embedded in the holder 370 by an insert molding method. Specifically, the terminal portions 381, 382, 383, 384, 385, 386 and the conductive portions 391, 392, 393, 394, 395, 396, 399 are joined with the plastic part 375 by the insert molding method, and exposed on the plastic part 375. The conductive portions 391, 392, 393, 394, 395, 396, 399 are not extended outward from the holder 370 along the direction z parallel to the central axis.

The four conductive portions 392, 393, 394, 395 are respectively electrically connected to four of the terminal portions 381, 382, 383, 384, 385, 386 (specifically, the four terminal portions 382, 383, 384, 385), and the four conductive portions 392, 393, 394, 395 are closer to the holder opening 373 than the four terminal portions 382, 383, 384, 385 to the holder opening 373.

In FIG. 3A to FIG. 3D, four pins 356 of the position detection unit 355 are respectively directly electrically connected to the four conductive portions 392, 393, 394, 395. The conductive portion 392 and the terminal portion 382 are located on the same one of the conductive parts 376 and thereby directly electrically connected to each other. The conductive portion 393 and the terminal portion 383 are located on the same one of the conductive parts 376 and thereby directly electrically connected to each other. The conductive portion 394 and the terminal portion 384 are located on the same one of the conductive parts 376 and thereby directly electrically connected to each other. The conductive portion 395 and the terminal portion 385 are located on the same one of the conductive parts 376 and thereby directly electrically connected to each other. The four terminal portions 382, 383, 384, 385 are directly electrically connected to a circuit board of an electronic device. Thus, the displacement relative to the holder 370 along the direction z parallel to the central axis of the detection magnet can be converted and obtained from an output signal of the position detection unit 355.

The position detection unit 355 is in a small outline non-leaded package with the four pins 356. The surface of the holder 370 includes a cross pattern 379 corresponding to or among the four conductive portions 392, 393, 394, 395. Specifically, the plastic part 375 of the holder 370 includes the cross pattern 379 (the cross pattern 379 of the plastic part 375 is marked with slash lines in FIG. 3A), and each of two stripe structures vertical to each other of the cross pattern 379 is in an unstraight stripe shape. The cross pattern 379 enables the conductive parts 376 to be exposed, and form and be separated into the four conductive portions 392, 393, 394, 395. Each of the four conductive portions 392, 393, 394, 395 is in a circular shape and has the same or similar dimension. An entirety of the four conductive portions 392, 393, 394, 395 has a length in the direction x, which is greater than a length in the direction x of the position detection unit 355, and it is favorable for the position detection unit 355 with the four pins 356 being respectively directly electrically connected to the four conductive portions 392, 393, 394, 395 so as to be disposed on the holder 370.

The holder 370 has a rectangular shape, wherein the rectangular shape of the holder 370 includes two long sides 377 and two short sides 378. That is, the holder 370 is substantially rectangular in shape. The position detection unit 355 and the terminal portions 381, 382, 383, 384, 385, 386 are close to one of the short sides 378 of the rectangular shape.

In FIG. 1A and FIG. 3A, the lens driving apparatus of the 3rd embodiment further includes at least one upper leaf spring and at least one lower leaf spring, wherein the upper leaf spring and the lower leaf spring are both connected to the carrier and arranged along the direction z parallel to the central axis. Thus, the carrier and the lens assembly are carried to be displaced along the direction z parallel to the central axis. In the 3rd embodiment, a number of the lower leaf spring is two, each of the lower leaf springs includes a connecting section, and the two connecting sections are respectively connected to the conductive portions 391, 396. Furthermore, the conductive portion 391 and the terminal portion 381 are located on the same one of the conductive parts 376 and thereby directly electrically connected to each other. The conductive portion 396 and the terminal portion 386 are located on the same one of the conductive parts 376 and thereby directly electrically connected to each other. Accordingly, current in the coil could be induced by an external driving current, wherein a conductive path of the external driving current is formed by the directly electrical connection between the two connecting sections and the conductive portions 391, 396 respectively, the directly electrical connection between the conductive portions 391, 396 and the terminal portions 381, 386 respectively, and the directly electrical connection between the terminal portions 381, 386 and the circuit board of the electronic device.

The data of the parameters of the lens driving apparatus according to the 3rd embodiment of the present disclosure are listed in the following Table 3, wherein the parameters are also shown as FIG. 3A. The definitions of these parameters shown in Table 3 are the same as those stated in the 1st embodiment with corresponding values in the 3rd embodiment.

TABLE 3
3rd Embodiment

| | | | |
|---|---|---|---|
| d1 (mm) | 0.37 | W (mm) | 5.62 |
| d2 (mm) | 0.28 | L/W | 1.34 |
| L (mm) | 7.52 | h (mm) | 0.2188 |

### 4th Embodiment

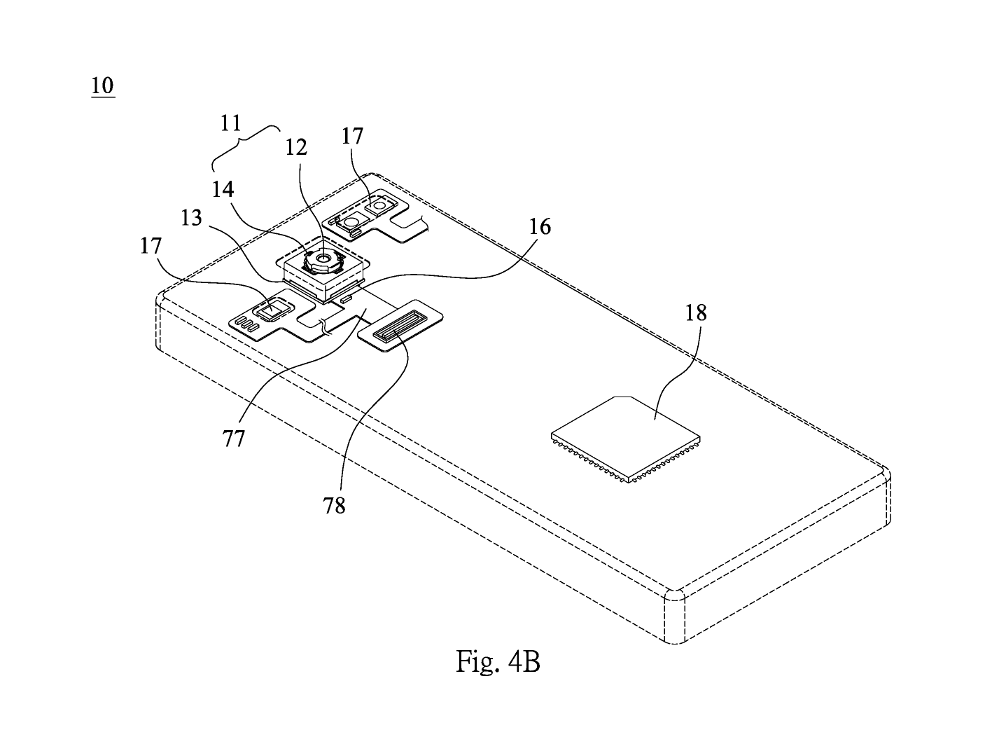

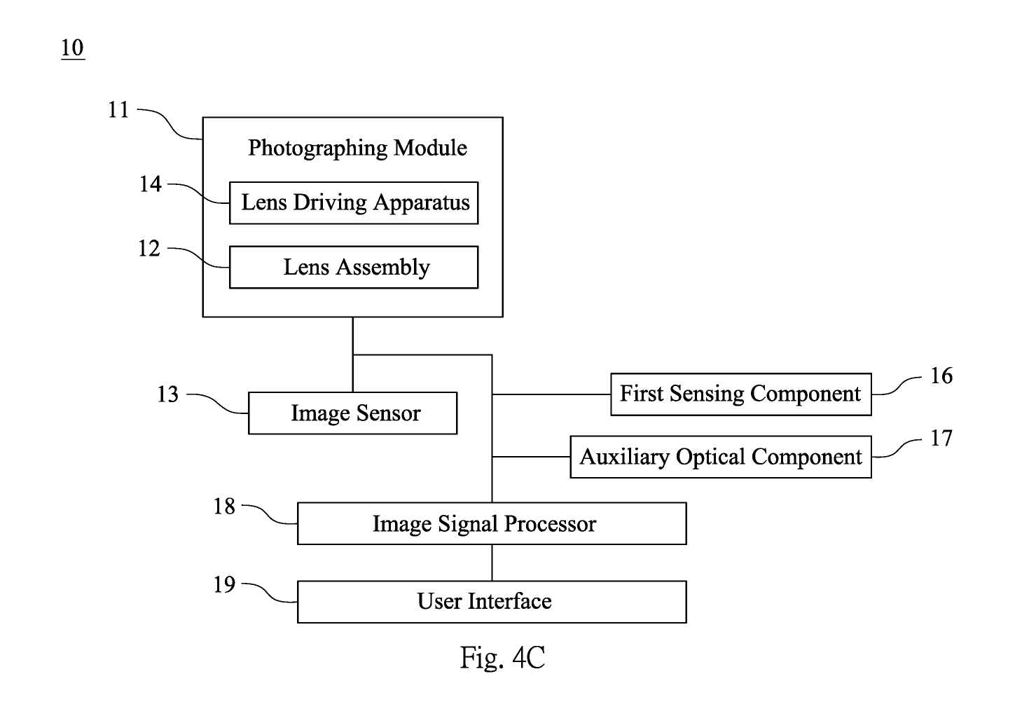

FIG. 4A shows a schematic view of an electronic device 10 according to the 2nd embodiment of the present disclosure, FIG. 4B shows another schematic view of the electronic device 10 according to the 2nd embodiment, and particularly, FIG. 4A and FIG. 4B are schematic views related to a camera of the electronic device 10. In FIG. 4A and FIG. 4B, the electronic device 10 of the 2nd embodiment is a smart phone, wherein the electronic device 10 includes a photographing module 11 and an image sensor 13. The photographing module 11 includes a lens driving apparatus 14 according to the present disclosure and a lens assembly 12, wherein the lens assembly 12 is assembled with a carrier (not shown herein) of the lens driving apparatus 14, and the image sensor 13 is disposed on an image surface (not shown herein) of the lens assembly 12 for receiving an imaging light from the lens assembly 12. Therefore, a better image quality can be achieved, and hence the high-end imaging requirements of modern electronic devices can be satisfied.

Moreover, the holder (not shown herein) of the lens driving apparatus 14 includes a plurality of terminal portions and a plurality of conductive portions. Accordingly, the circuit routing required by the lens driving apparatus 14 could be implemented by the directly electrical connection between the terminal portions and the conductive portions respectively, the directly electrical connection between the conductive portions and a position detection unit (not shown herein), a lower leaf spring (not shown herein) and so on of the lens driving apparatus 14, and the directly electrical connection between the terminal portions and a circuit board 77, which carries the image sensor 13.

Furthermore, the user activates the capturing mode via a user interface 19 of the electronic device 10, wherein the user interface 19 of the 2nd embodiment can be a touch screen 19a, a button 19b and etc. At this moment, the imaging light is converged on the image sensor 13 of the lens assembly 12, and the electronic signal associated with image is output to an image signal processor (ISP) 18.

FIG. 4C shows a block diagram of the electronic device 10 according to the 2nd embodiment, and in particular, the block diagram is related to the camera of the electronic device 10. In FIG. 4A to FIG. 4C, the photographing module 11 can further include at least one auxiliary optical component 17 and at least one first sensing component 16. The auxiliary optical component 17 can be a flash module for compensating for the color temperature, an infrared distance measurement component, a laser focus module and etc. The first sensing component 16 can have functions for sensing physical momentum and kinetic energy, and thereby can be an accelerator, a gyroscope, a Hall sensor and a Hall element, to sense shaking or jitters applied by hands of the user or external environments. Accordingly, the functions of the lens driving apparatus 14 of the photographing module 11 can be aided and enhanced to achieve the superior image quality. Furthermore, the electronic device 10 according to the present disclosure can have a capturing function with multiple modes, such as taking optimized selfies, high dynamic range (HDR) under a low light condition, 4K resolution recording, etc. Additionally, the user can visually see the captured image of the camera through the touch screen 19a and manually operate the view finding range on the touch screen 19a to achieve the auto focus function of what you see is what you get.

Furthermore, in FIG. 4B, the photographing module 11, the first sensing component 16 and the auxiliary optical component 17 can be disposed on the circuit board 77 (the circuit board 77 is a flexible printed circuit board, FPC) and electrically connected with the associated components, such as the imaging signal processor 18, via a connector 78 to perform a capturing process. Since the current electronic devices, such as smart phones, have a tendency of being compact, the way of firstly disposing the photographing module and related components on the flexible printed circuit board and secondly integrating the circuit thereof into the main board of the electronic device via the connector can satisfy the requirements of the mechanical design and the circuit layout of the limited space inside the electronic device, and obtain more margins. The autofocus function of the photographing module can also be controlled more flexibly via the touch screen of the electronic device. In the 2nd embodiment, the electronic device 10 includes a plurality of first sensing components 16 and a plurality of auxiliary optical components 17. The first sensing components 16 and the auxiliary optical components 17 are disposed on the circuit board 77 and at least one other flexible printed circuit board (its reference numeral is omitted) and electrically connected with the associated components, such as the image signal processor 18, via corresponding connectors to perform the capturing process. In other embodiments (not shown herein), the first sensing components and the auxiliary optical components can also be disposed on the main board of the electronic device or carrier boards of other types according to requirements of the mechanical design and the circuit layout.

In addition, the electronic device 10 can further include but not be limited to a wireless communication unit, a control unit, a storage unit, a random access memory, a read-only memory, or a combination thereof.

### 5th Embodiment

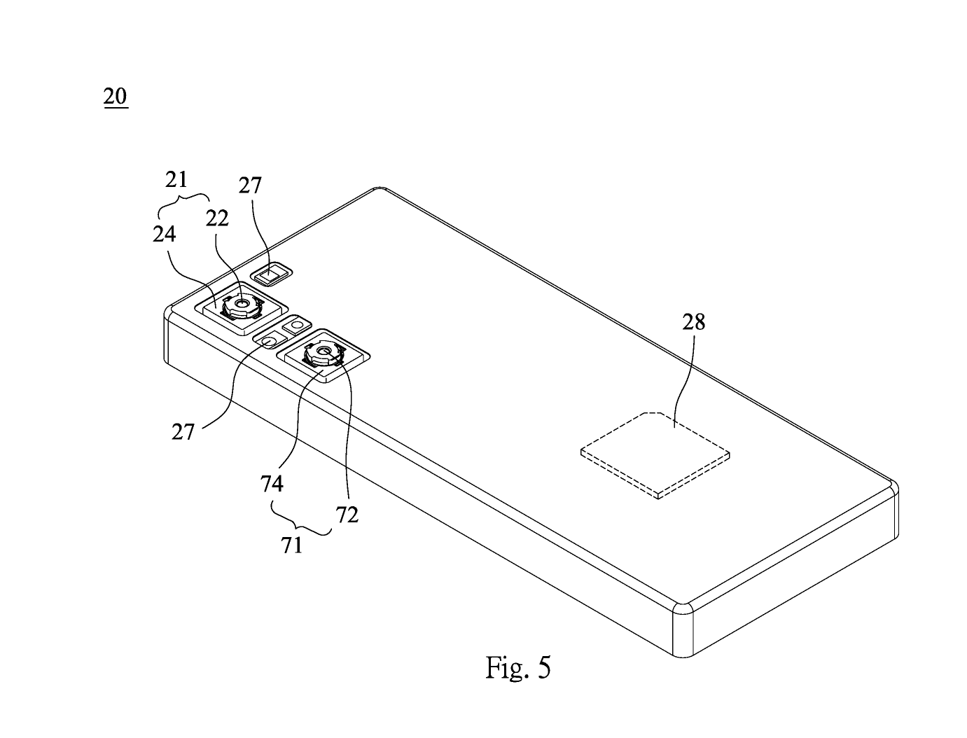

FIG. 5 shows an electronic device 20 according to the 5th embodiment of the present disclosure. In FIG. 5, the electronic device 20 of the 5th embodiment is a smart phone, wherein the electronic device 20 includes photographing modules 21, 71 and respectively corresponding image sensors (not shown herein). The photographing module 21 includes a lens driving apparatus 24 and a lens assembly 22, wherein the lens assembly 22 is assembled with a carrier (not shown herein) of the lens driving apparatus 24, and the image sensor is for receiving an imaging light from the lens assembly 22. The photographing module 71 includes a lens driving apparatus 74 and a lens assembly 72, wherein the lens assembly 72 is assembled with a carrier (not shown herein) of the lens driving apparatus 74, and the image sensor is for receiving an imaging light from the lens assembly 72.

Furthermore, at least one of the lens driving apparatuses 24 and 74 is a lens driving apparatus according to the present disclosure, and the lens driving apparatuses 24 and 74 may not have the same optical properties. In the photographing procedure of the electronic device 20, two images can be captured by the photographing modules 21 and 71 with an aid of an auxiliary optical component 27, and then the required effects like zooming, delicate images would be achieved by the processors (such as an image signal processor 28 and so on) equipped in the electronic device 20.

### 6th Embodiment

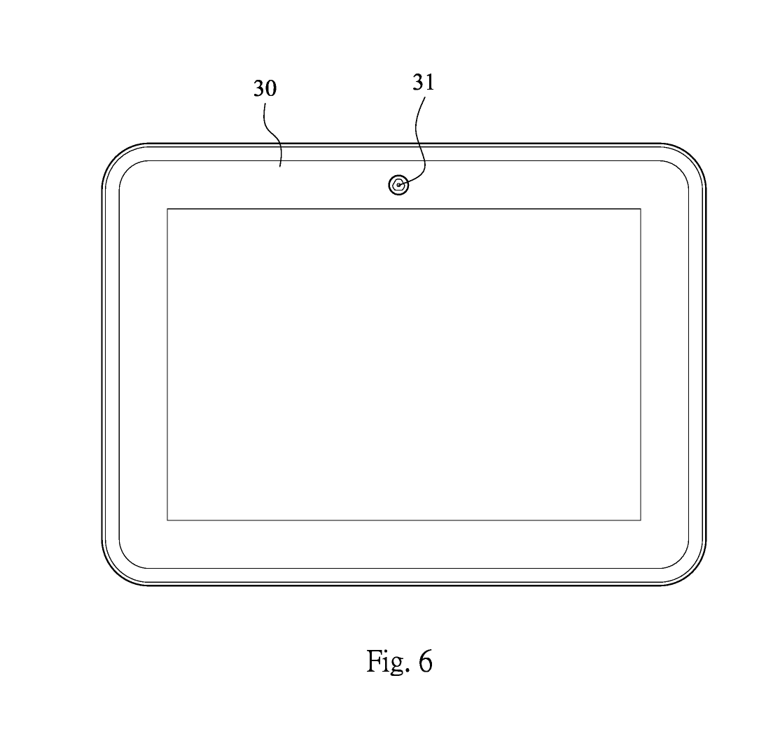

FIG. 6 shows an electronic device 30 according to the 6th embodiment of the present disclosure. The electronic device 30 of the 6th embodiment is a tablet personal computer, wherein the electronic device 30 includes a photographing module 31 and an image sensor. The photographing module 31 includes a lens driving apparatus (not shown herein) according to the present disclosure and a lens assembly, wherein the lens assembly is to assembled with a carrier of the lens driving apparatus, and the image sensor is for receiving an imaging light from the lens assembly.

### 7th Embodiment

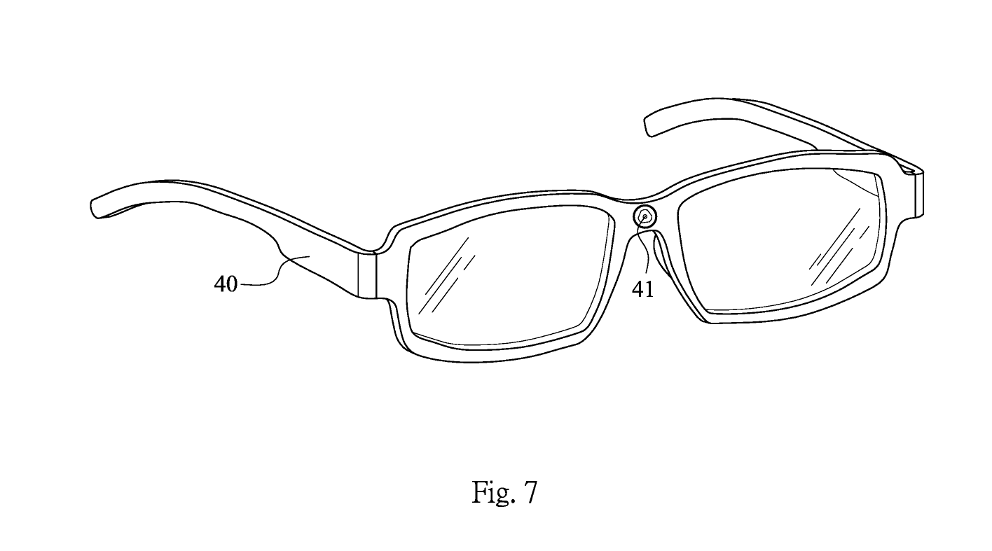

FIG. 7 shows an electronic device 40 according to the 7th embodiment of the present disclosure. The electronic device 40 of the 7th embodiment is a wearable device, wherein the electronic device 40 includes a photographing module 41 and an image sensor. The photographing module 41 includes a lens driving apparatus (not shown herein) according to the present disclosure and a lens assembly, wherein the lens assembly is assembled with a carrier of the lens driving apparatus, and the image sensor is for receiving an imaging light from the lens assembly.

Although the present disclosure has been described in considerable detail with reference to the embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims.

What is claimed is:

1. A lens driving apparatus, which is for driving a lens assembly, the lens driving apparatus comprising:
a holder comprising a holder opening;
a metal cover coupled to the holder and comprising a cover opening, which is disposed correspondingly to the holder opening;
a carrier having a central axis, wherein the carrier is for being assembled with the lens assembly, the carrier is disposed in the metal cover and is displaceable relative to the holder along a direction parallel to the central axis;
at least one detection magnet coupled to an end of the carrier, wherein the end of the carrier is close to the holder;
at least one position detection unit disposed on the holder and correspondingly to the detection magnet, wherein the position detection unit is for detecting a displacement along the direction parallel to the central axis of the detection magnet;
a coil wound around and disposed on an outer surface of the carrier; and
at least two driving magnets disposed in the metal cover and correspondingly to the coil;
wherein the holder further comprises:
a plurality of terminal portions extended outward from the holder along the direction parallel to the central axis; and
a plurality of conductive portions exposed on a surface of the holder, wherein four of the conductive portions are arranged as a grid array of two rows and two columns, and the four of the conductive portions are disposed correspondingly to the position detection unit.

2. The lens driving apparatus of claim 1, wherein the terminal portions and the conductive portions are embedded in the holder by an insert molding method.

3. The lens driving apparatus of claim 1, wherein the position detection unit is in a small outline non-leaded package.

4. The lens driving apparatus of claim 1, wherein the surface of the holder comprises a cross pattern corresponding to the four of the conductive portions, a first width of the cross pattern is d1, a second width of the cross pattern is d2, and the following conditions are satisfied:
0.05 mm<d1<0.8 mm, and
0.05 mm<d2<0.8 mm.

5. The lens driving apparatus of claim 4, wherein the first width of the cross pattern is d1, the second width of the cross pattern is d2, and the following conditions are satisfied:
0.15 mm<d1<0.55 mm; and
0.15 mm<d2<0.55 mm.

6. The lens driving apparatus of claim 1, further comprising:
at least one upper leaf spring; and
at least one lower leaf spring, wherein the upper leaf spring and the lower leaf spring are both connected to the carrier and arranged along the direction parallel to the central axis, the lower leaf spring is disposed on the end of the carrier close to the holder, the lower leaf spring comprises a connecting section, and the connecting section is electrically connected to another one of the conductive portions of the holder.

7. The lens driving apparatus of claim 6, wherein the detection magnet and the position detection unit are arranged along the direction parallel to the central axis.

8. The lens driving apparatus of claim 1, wherein the four of the conductive portions are electrically connected to four of the terminal portions, respectively, and the four of the conductive portions are closer to the holder opening than the four of the terminal portions to the holder opening.

9. The lens driving apparatus of claim 1, wherein the carrier comprises at least one notch portion accommodating the detection magnet, and an opening of the notch portion faces the holder.

10. The lens driving apparatus of claim 1, wherein a thickness of the position detection unit is h, and the following condition is satisfied:
h<1.0 mm.

11. The lens driving apparatus of claim 1, wherein the conductive portions are not extended outward from the holder along the direction parallel to the central axis.

12. The lens driving apparatus of claim 1, wherein the holder has a rectangular shape, a length of each of two long sides of the rectangular shape is L, a length of each of two short sides of the rectangular shape is W, and the following condition is satisfied:
1.20<L/W<1.80.

13. A photographing module, comprising:
the lens driving apparatus of claim 1; and
the lens assembly assembled with the carrier of the lens driving apparatus.

14. An electronic device, comprising:
the photographing module of claim 13; and
an image sensor for receiving an imaging light from the lens assembly.

15. A lens driving apparatus, which is for driving a lens assembly, the lens driving apparatus comprising:
a holder comprising a holder opening;
a metal cover coupled to the holder and comprising a cover opening, which is disposed correspondingly to the holder opening;
a carrier having a central axis, wherein the carrier is for being assembled with the lens assembly, the carrier is disposed in the metal cover and is displaceable relative to the holder along a direction parallel to the central axis;
at least one detection magnet coupled to an end of the carrier, wherein the end of the carrier is close to the holder;
at least one position detection unit disposed on the holder and correspondingly to the detection magnet, wherein the position detection unit is for detecting a displacement along the direction parallel to the central axis of the detection magnet;
a coil wound around and disposed on an outer surface of the carrier; and
at least two driving magnets disposed in the metal cover and correspondingly to the coil;
wherein the holder further comprises:
a plurality of terminal portions extended outward from the holder along the direction parallel to the central axis; and
a plurality of conductive portions exposed on a surface of the holder, wherein at least four of the conductive portions are disposed correspondingly to the position detection unit.

16. The lens driving apparatus of claim 15, wherein the surface of the holder comprises a cross pattern corresponding to the at least four of the conductive portions, a first width of the cross pattern is d1, a second width of the cross pattern is d2, and the following conditions are satisfied:
0.05 mm<d1<0.8 mm, and
0.05 mm<d2<0.8 mm.

17. The lens driving apparatus of claim 16, wherein the first width of the cross pattern is d1, the second width of the cross pattern is d2, and the following conditions are satisfied:
0.15 mm<d1<0.55 mm; and
0.15 mm<d2<0.55 mm.

18. The lens driving apparatus of claim 15, wherein the at least four of the conductive portions are electrically connected to at least four of the terminal portions, respectively, and the at least four of the conductive portions are closer to the holder opening than the at least four of the terminal portions to the holder opening.

19. The lens driving apparatus of claim 15, wherein the holder has a rectangular shape, and the position detection unit and the terminal portions are close to one of two short sides of the rectangular shape.

20. The lens driving apparatus of claim 15, wherein the holder has a rectangular shape, a length of each of two long sides of the rectangular shape is L, a length of each of two short sides of the rectangular shape is W, and the following condition is satisfied:
1.20<L/W<1.80.

21. The lens driving apparatus of claim 15, wherein the carrier comprises at least one notch portion accommodating the detection magnet, an opening of the notch portion faces the holder, the notch portion comprises a plurality of rib structures, and the rib structures are for contacting the detection magnet and fixedly disposing the detection magnet on the carrier.

22. A photographing module, comprising:
the lens driving apparatus of claim 15; and
the lens assembly assembled with the carrier of the lens driving apparatus.

23. An electronic device, comprising:
the photographing module of claim 22; and
an image sensor for receiving an imaging light from the lens assembly.
